(19) United States
(12) Patent Application Publication
(10) Pub. No.: US 2024/0056443 A1
(43) Pub. Date: Feb. 15, 2024

(54) SECURE CROSS-PLATFORM SMART HOSTING, CREDENTIAL SHARING, AND IDENTITY MANAGEMENT

(71) Applicant: Abalta Technologies, Inc., San Diego, CA (US)

(72) Inventor: Pavel Stankoulov, San Diego, CA (US)

(73) Assignee: Abalta Technologies, Inc., San Diego, CA (US)

(21) Appl. No.: 18/265,817

(22) PCT Filed: Dec. 31, 2021
(86) PCT No.: PCT/US2021/065827

§ 371 Date: Jun. 7, 2023

Related U.S. Application Data
(60) Provisional application No. 63/133,116, filed on Dec. 31, 2020.

(51) Int. Cl. H04L 9/40; H04L 67/141

(52) U.S. Cl. CPC H04L 63/0869; H04L 67/141; H04L 63/0823

(57) ABSTRACT

Systems, methods, devices, and/or other components to implement cross-platform smart hosting are described. Smart devices or “smart hosts” such as smartphones, smart watches, tablets, etc. may be used as identity keys and/or data servers when associated with connected client devices or “clients” such as in-vehicle infotainment systems, smart televisions, medical systems, internet of things (IoT) devices, industrial devices, etc. The smart host may enable access to personal information and data, such as contacts, calendars, e-mails, history, media, login information for various services, etc. A high degree of protection of personal data may be achieved by not storing login information at the clients and encrypting cached data using keys that are only provided when the smart host is present (e.g., within a specified physical or spatial proximity threshold to a client).

### CROSS-REFERENCE TO RELATED APPLICATIONS

This application is a National Phase application of Patent Cooperation Treaty (PCT) Application serial number PCT/US2021/065827, filed on Dec. 31, 2021. PCT application serial number PCT/US2021/065827 claims priority to U.S. Provisional patent application Ser. No. 63/133,116, filed on Dec. 31, 2020.

### BACKGROUND

Many modern devices such as in-vehicle infotainment systems, smart TVs, medical systems, internet of things (IoT) devices, industrial devices, etc., access different cloud services and require users to login (or otherwise sign in) to one or more services on those devices. Often the sign-in process may be tedious as the device might not have display or has difficult input methods. The process becomes even more complicated for end consumer devices where the user installs or enables multiple applications or services, requiring sign into multiple accounts associated with different vendors. For example, an end consumer might have multiple e-mail accounts (multiple personal accounts with different vendors, a work account, a shared family account, etc.) that have e-mail messages, calendars, contacts, and other services associated with them. To use these accounts in a connected in-vehicle system for example, the end consumer has to manually login to each account (e.g., by typing a username and password). If passwords change (as often required by some providers), the end consumer must re-login to those accounts.

Furthermore, devices may be shared among multiple users. For example, a device may be located in a rental car or equipment, or a device may be shared among users in the same household, company, office, or community. In such scenarios, any logged-in accounts, and data (which may be potentially sensitive) might be accessible to other users. To avoid this, a user must manually delete any sensitive data, and/or manually log out every time the user finishes using the shared device.

Therefore, there exists a need for end-users to easily login and access accounts and data via client devices, while login information and data are automatically deleted or protected.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates an example overview of one or more embodiments described herein, in which a smart host provides account delegation credentials to a client;

FIG. 2 illustrates an example overview of one or more embodiments described herein, in which a smart host provides data services to a client;

FIG. 3 illustrates an example overview of one or more embodiments described herein, in which a smart host provides identity services to a client;

FIG. 4 illustrates a schematic block diagram of a portion of an environment of one or more embodiments described herein, in which identity information may be shared between a smart host and a client;

FIG. 5 illustrates a schematic block diagram of a portion of the environment of FIG. 4, in which security keys and certificates are shared between a smart host and a client;

FIG. 6 illustrates a schematic block diagram of a portion of the environment of FIG. 4, including elements of a cloud service of some embodiments;

FIG. 7 illustrates a schematic block diagram of a portion of the environment of FIG. 4, including elements of a smart host of some embodiments;

FIG. 8 illustrates a schematic block diagram of a portion of the environment of FIG. 4, including elements of a client of some embodiments;

FIG. 9 illustrates a message flow diagram of an authentication sequence of one or more embodiments described herein;

FIG. 10 illustrates a message flow diagram of a certificate generation protocol of one or more embodiments described herein;

FIG. 11 illustrates a message flow diagram of a portion of a secure connection protocol of one or more embodiments described herein;

FIG. 12 illustrates a message flow diagram of another portion of the secure connection protocol of FIG. 11;

FIG. 13 illustrates a flow chart of an exemplary process that delegates account information from a smart host to a client;

FIG. 14 illustrates a flow chart of an exemplary process that provides data services from a smart host to a client;

FIG. 15 illustrates a flow chart of an exemplary process that identifies a user at a client;

FIG. 16 illustrates a flow chart of an exemplary process that manages certificates at a client;

FIG. 17 illustrates a flow chart of an exemplary process that manages certificates at a smart host; and

FIG. 18 illustrates a schematic block diagram of one or more exemplary devices used to implement various embodiments.

### DETAILED DESCRIPTION

The following detailed description describes currently contemplated modes of carrying out exemplary embodiments. The description may be not to be taken in a limiting sense, but may be made merely for the purpose of illustrating the general principles of some embodiments, as the scope of the disclosure may be best defined by the appended claims.

Various features are described below that may each be used independently of one another or in combination with other features. Broadly, some embodiments generally provide systems, methods, devices, and/or other components to implement cross-platform smart hosting.

Such systems, methods, devices, and/or other components may be referred to as “the system” throughout the disclosure. Such references to “the system” shall be understood by one of ordinary skill in the art to include various combinations or sub-combinations of elements and/or individual elements, as described herein.

Smart devices or “smart hosts” such as smartphones, smart watches, tablets, etc. may be used as identity keys and/or data servers when associated with connected client devices or “clients” such as in-vehicle infotainment systems, smart TVs, medical systems, IoT devices, industrial devices, etc. The smart host may enable access to personal information and data, such as contacts, calendars, e-mails, history, media, login information for various services, etc. A high degree of protection of personal data may be achieved by not storing login information at the clients and encrypting cached data using keys that are only provided when the smart host is present (e.g., within a specified physical or spatial proximity threshold to a client).

Users already carry personal smart devices such as smartphones, smartwatches, tablets, smart wearables, etc. On such devices, the users have already provisioned, installed, logged-in to, and/or otherwise configured various services and applications. The users trust these personal smart devices. Furthermore, the smart devices may often come with additional biometric sensors and software, such as fingerprint sensors, face recognition camera, voice recognition, etc., that may be used to authenticate users.

The smart devices carried by users may serve as an identity key or other type of smart host for connected clients such as in-vehicle infotainment systems, smart TVs, medical systems, IoT devices, industrial devices, etc. The smart host may act as a data server to the client by offering access to authorized data from the smart host or the cloud. The user may have full control of which accounts and what data may be provided from, or via, the smart host to the connected client.

The system offers a high degree of protection of personal data because login information is not stored at the clients (nor at a central single sign-on entity) and any cached data may be encrypted using keys that are only provided when the smart host is present. For certain types of data, the system may require biometric verification of the user (e.g., using a fingerprint sensor, facial recognition, voice recognition, or another biometric authentication feature) to verify that an authorized user is in possession of the smart host. This way when the user does not have access to the client, personal information, logins, and/or other data may be not accessible to other people that have access to the client.

The system may provide upgraded security when using various resources, such as embedded resources, via the smart host. For example, smart hosts such as smart phones may include more advanced security components and/or receive security upgrades or updates at much shorter intervals than devices such as vehicle head units.

When an authorized smart host connects to the client, the user may be quickly re-authenticated and have access to private data from the client. This solution removes the need for the end-user to manually login to each service on the client system (e.g., by providing a username/password combination for each service). The solution also improves safety for in-vehicle systems as a user will not need to sign into services while driving. In addition, private user data may be automatically deleted and/or protected when the smart host disconnects from the client such that the private user data is not available to others. Such an approach may be especially useful for shared clients (e.g., rental cars, shared professional equipment, etc.). The system allows for easy switching between different user profiles while keeping private data separate and protected.

Each client may be set up with different profiles that store preferences, service data, etc. for the different authorized users. The user may automatically switch to the associated profile by simply connecting an authorized smart host to the client. If required, the user may provide additional authentication using biometrics or other ways (e.g., a PIN). When the smart host is disconnected from the client, the profile may be automatically locked or otherwise deactivated. Any sensitive data may be encrypted, deleted, or otherwise protected.

Accounts and services that are configured on the smart host may be exposed to the connected client without the need for additional login. The user may control which accounts and what data to provide to each connected client. The system may support access to cloud accounts or local application accounts from the smart host.

The proposed solution may be used for clients that do not have access to the Internet. The smart host may provide access to data from the smart host or the cloud.

There may also be a level of biometric security that requires the user to touch the fingerprint sensor, use face or voice recognition, or use other biometric methods to prove that the authorized person has possession of the smart host. This way when the user does not have access to the client, personal information, logins, and data may be not accessible to other people that have access to the same client. When the user returns to use the client, with the smart host, the user may be quickly re-authenticated and have access to their data from the client. This solution removes the need for the end-user to login for each needed service on their client system. There may be no need to enter usernames or passwords for services to be used on the client. This may be especially useful for shared clients, e.g., rental cars, shared professional equipment, etc. The proposed system allows easy switching between different user profiles while keeping the individual data separate and protected.

The smart host may include, utilize, and/or otherwise implement resources such as a smart host software development kit (SDK). The client may similarly include, utilize, and/or otherwise implement resources such as a client SDK. Throughout this disclosure, the term “smart host resources” may be used to refer to any resources available to the smart host (and/or the smart host itself), such as processors, storages, communication interfaces, applications or software modules included in the smart host SDK, etc. Similarly, throughout this disclosure the term “client resources” may be used to refer to any resources available to the client (and/or the client itself), such as processors, storages, communication interfaces, applications or software modules included in the client SDK, etc.

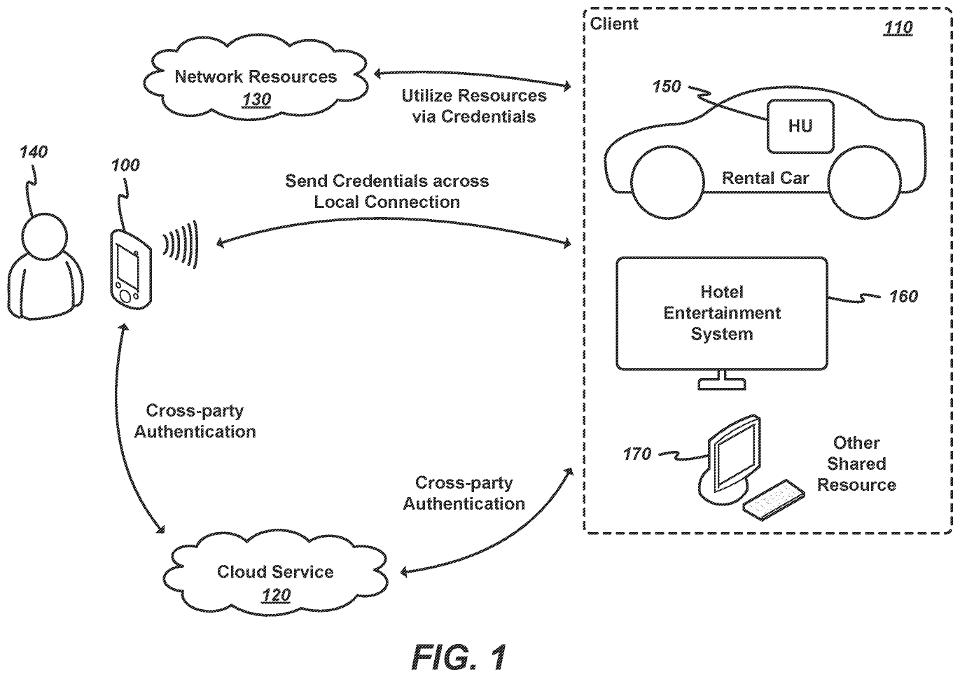

FIG. 1 illustrates an example overview of one or more embodiments described herein, in which a smart host 100 provides account delegation credentials to a client 110. As shown, smart host 100 may communicate with client 110 across a local connection. Smart host 100 and client 110 may be able to communicate with cloud services 120. Client 110 may be able to access various network resources 130. Smart host 100 may be associated with a user 140 and examples of clients 110 include a rental car head unit 150, hotel entertainment system 160, and other shared resources 170.

Smart host 100 may be, include, and/or utilize one or more devices or components such as smartphones, tablets, wearable devices such as a smart watches, etc. Smart host 100 may be able to communicate wirelessly and may be able to access resources such as the Internet.

Client 110 may be, include, and/or utilize one or more devices or components such as in-vehicle entertainment systems, smart televisions, personal computers, medical devices, industrial devices, etc. Client 110 may be utilized by multiple users 140. Client 110 may be able to communicate wirelessly and/or across various networks (e.g., a cellular network, Wi-Fi, etc.) and may be able to access resources such as the Internet. Client 110 may include components and/or resources such as a display or other user interface (UI) elements (e.g., buttons, keypads, voice activated controls, etc.). Client 110 may be able to execute various client applications.

Cloud service 120 may be, include, and/or utilize devices or components such as servers and may be accessible via resources such as the Internet (e.g., via a resource such as an application programming interface (API)).

Each network resource 130 may provide data and/or services over a resource such as the Internet and/or other appropriate networks. Network resources 130 may include, for instance, email providers, cloud storage solutions, business accounts, entertainment streaming services, etc.

Each user 140 may be a person or other entity (e.g., another smart device) that may be associated with various network resources 130 and/or may at least partly direct the operations of smart host 100. Each user 140 may be associated with various accounts or other credentials that may be associated with network resources 130.

In this example, the smart host 100 may be connected to the client 110 over a local connection (e.g., Bluetooth (BT), ultra-wide band (UWB), Wi-Fi, cable, etc.). The local connection may include or utilize a secure, encrypted channel. Encryption keys, certificates, and/or other security credentials may be managed by cloud service 120. The smart host 100 and client 110 may perform cross-party authentication via the cloud service 120. Such cross-party authentication may include analysis of certificates and/or other secure identification resources using various stored and/or downloaded keys and/or other resources.

The smart host 100 may provide access credentials to various service accounts managed by network resources 130 to the connected client 110 and/or client applications (e.g., a web browser, music player, streaming application, etc.) over the secure local connection. Access credentials may be provided by starting temporary client sessions with the network resources 130 from the smart host 100 using a resource such as the smart host resources. Session secrets may be passed to authorized client applications via client 110 using a resource such as the client resources. The client applications may access network resources 130 to obtain data or receive services by providing the session secret information for identification and/or authorization.

When the smart host 100 is disconnected from the client 110 or the user session is ended in some other way (e.g., timeout since last action, client application is closed, etc.), the smart host 100 may terminate, via a resource such as the smart host resources, any active temporary client sessions associated with client 120 and/or network resources 130. At this point, the client applications may no longer be able to access the network resources 130 until new temporary client sessions are started via the authorized smart host 100.

Rental car head unit 150 may be a device associated with a vehicle that is able to provide various services, such as streaming entertainment, navigation, voice services, etc. In some cases, the rental car head unit 150 may provide access to one or more networks (e.g., a cellular network). Users 140 may wish to utilize network resources 130 such as streaming music via the rental car head unit 150 without having to login to a subscription account on the shared rental car head unit 150. When a smart host 100 is connected to the rental car head unit 150, a streaming media service or associated profile may be identified and automatically launched based on user preferences associated with the smart host 100.

Hotel entertainment system 160 may be a device associated with a hotel that provides services such as streaming entertainment, room service ordering, resource reservation or booking services, checkout or other administration, etc. Users 140 may wish to utilize streaming entertainment services associated with a subscription account without providing username and password information directly to the hotel entertainment system 160. For example, a user 140 may launch a streaming video service and the user login and/or profile information may automatically be applied at the hotel entertainment system 160. As another example, users 140 may wish to share payment or other sensitive information only with trusted resources, such as clients 110 that are authenticated via cloud service 120.

Other shared resource 170 may be a device such as a shared PC (e.g., a PC at a public library or hotel business center), industrial device, medical device, and/or any other resource that may be shared among multiple users 140 and may utilize or provide services that require login or other identity validation or verification. For example, user identity information may be extracted based on a local connection to a smart host 100. Such information may be logged to monitor usage of workplace resources.

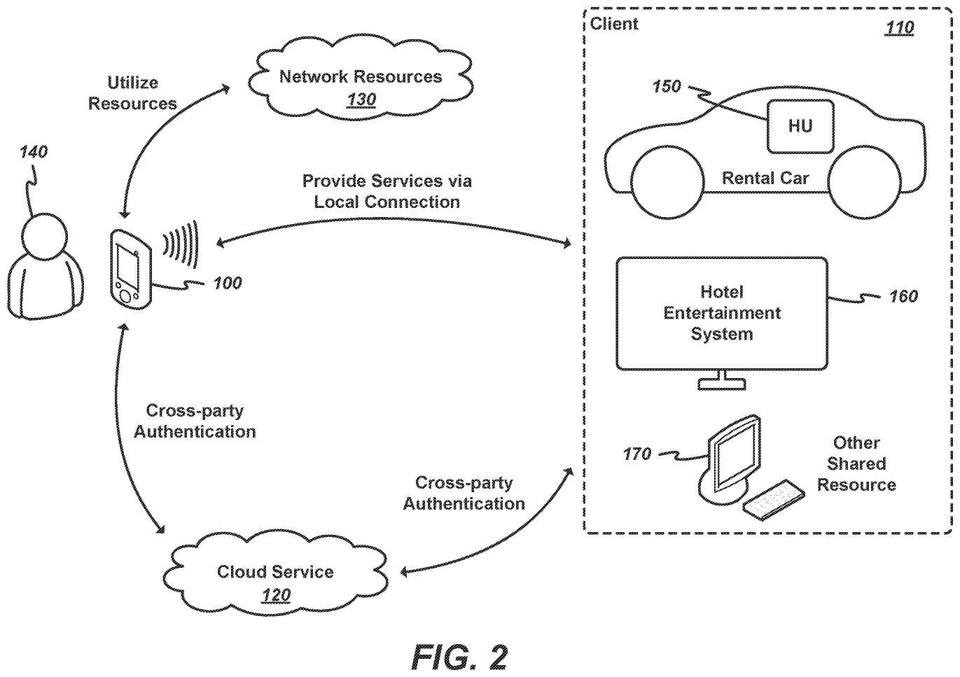

FIG. 2 illustrates an example overview of one or more embodiments described herein, in which a smart host 100 provides data services to a client 110. In this configuration, login credentials are not shared with the client 110 and application or other data is provided via the local connection.

In this example, smart host 100 may act as a data server. As such, the client 110 does not need to have an Internet connection or other network connectivity. Any client application may have access to data in unified way without the need to support the various provider interfaces that may be associated with network resources 130. A user 140 does not need to enter any login information on the client 110 (or otherwise share such information with the client) as the user may login (or have previously logged in) to those services on the smart host 100.

In this example, after the smart host 100 is connected securely to the client 110 over the local connection, the smart host 100, via a resource such as the smart host resources, may publish one or more smart host services. The smart host services may utilize network resources 130, smart host applications, and/or other appropriate resources. Authorized client applications may access smart host services through a resource such as the client resources. Smart host services may include services such as, for instance, a file transfer protocol, email or other messaging service(s), services provided via smart host applications 440, etc. Smart host services may be provided via an interface that uses standard protocols such as, for example, Internet message access protocol (IMAP), post office protocol 3 (POP3), simple mail transfer protocol (SMTP) for email, CalDAV, iCalendar for calendars, CardDAV for contacts, session initiation protocol (SIP) for messaging, etc., and/or may use custom protocols.

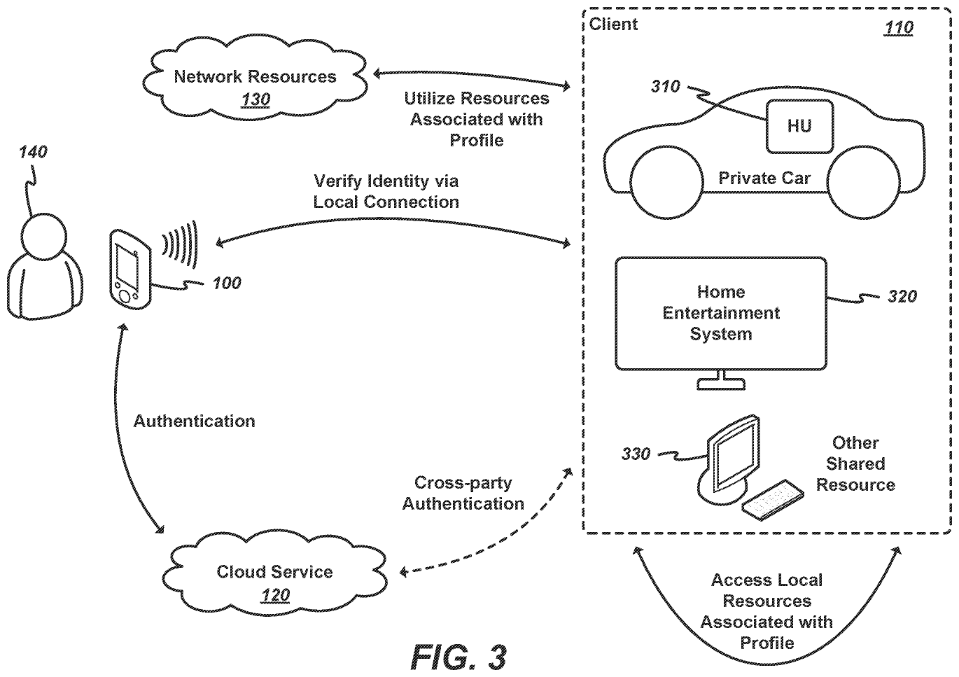

FIG. 3 illustrates an example overview of one or more embodiments described herein, in which a smart host 100 provides identity services to a client 110. As shown, in this example, example clients 110 include a private car head unit 310, a home entertainment system 320, and/or other shared resources 330.

In this mode, when the smart host 100 is connected to the client 110 over the local connection, a resource such as the smart host resources may exchange authentication (or other identification) information with a resource such as the client resources over a secure communication channel associated with the local connection. The authenticity of the smart host 100 and the client 110 may be validated using digital certificates managed by cloud service 120. Because the client 110 may not have a real-time connection to cloud service 120, cross-party authentication information may be pre-loaded, or otherwise stored, at the client 110 when such a connection was available (e.g., private and/or public keys, certificates, and/or other information may be stored at the client 110 during manufacture or installation of features or applications).

After the client 110, via a resource such as the client resources, successfully identifies the smart host 100, the client 110 may perform automatic and secure profile switching. Optional additional user authentication may be performed via the smart host 100 and/or client 110.

Any sensitive data stored on the client 110 may be locked and inaccessible unless the associated user 140 connects an authorized smart host 100 to the client 110 via the local connection.

Private car head unit 310 may be similar to rental car head unit 150. In this example, the private car head unit 310 may be associated with multiple members of a household that share the private car. Each user 140 may be associated with different accounts, profiles, settings, and/or other configuration information. Thus, for example, the private car head unit 310 may utilize a different streaming radio account depending on the driver of the private car, as identified by the locally connected smart host 100.

Home entertainment system 320 may be similar to hotel entertainment system 160. In this example, multiple family users 140 may each be associated with a different streaming media service or service profile. Based on a local connection to smart host 100, client 110 may access such services or profiles associated with the user 140 of the locally connected smart host 100 (e.g., by automatically selecting a profile for the streaming media service).

Other shared resource 330 may be similar to other shared resource 170. Multiple users 140 of a shared PC may each be associated with a different email address and/or other such online accounts. Based on a local connection to smart host 100, client 110 may access such online accounts associated with the user 140 of the locally connected smart host 100 (e.g., by utilizing previously stored login information such as username and password).

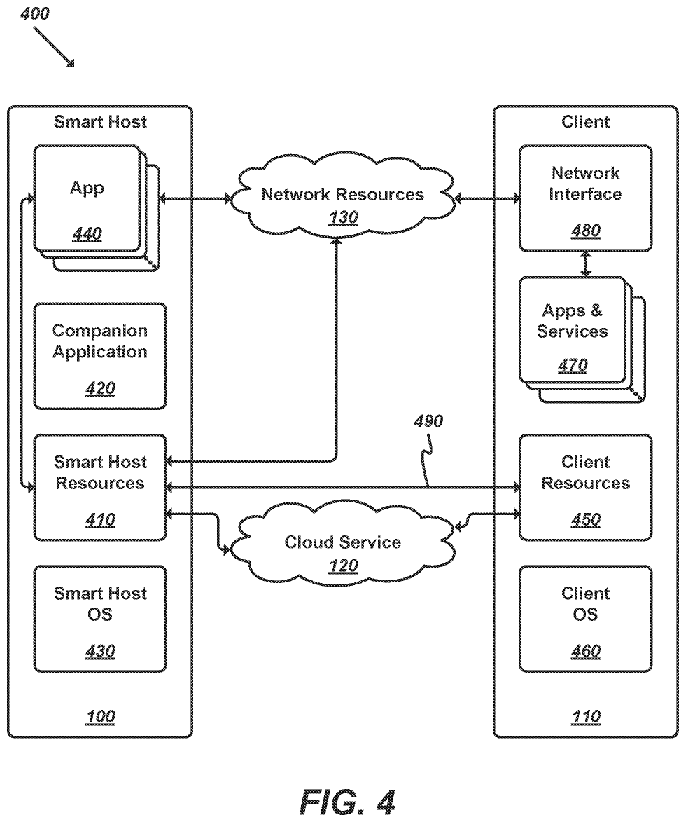

FIG. 4 illustrates a schematic block diagram of a portion of an environment 400 of one or more embodiments described herein, in which identity information may be shared between smart host 100 and client 110. As shown, smart host 100 may include smart host resources 410, companion application 420, smart host operating system (OS) 430, and various smart host applications 440. Client 110 may include client resources 450, client OS 460, various applications and/or services 470, and network interface 480. Smart host 100 and client 110 may communicate across local connection 490.

Smart host 100 and client 110 may exchange information via a local connection 490. Cloud service 120 may provide authentication and/or validation services to smart host 100 and/or client 110. Smart host 100 and/or client 110 may access network resources 130 across various appropriate network channels (e.g., cellular, Wi-Fi, the Internet, etc.).

Cloud service 120 may be a set of web and database servers and/or other appropriate resources that provides the necessary resources to the smart host resources 410 and/or client resources 450 over a resource such as the Internet. Cloud service 120 may be associated with various clients 110 and/or types of clients in some embodiments. In some embodiments, a client 110 and/or type of client may be associated with a dedicated or specialized cloud service 120. For instance, a vehicle manufacturer may implement a dedicated cloud service 120, where all associated clients 110 are vehicles produced by that vehicle manufacturer.

Smart host 100 may be a computing device that users 140 carry with them such as a smartphone, tablet, or wearable device such as smartwatch, smart glasses, etc. The smart host 100 may have data connectivity to the Internet (and/or other appropriate resources) to access the network resources 130 and/or cloud service 120. Smart host 100 may be able to communicate with clients 110 over local connection 490 using BT, UWB, near-field communication (NFC), universal serial bus (USB), Wi-Fi, or other appropriate channels.

Client 110 may be any device that is able to utilize services offered by smart host 100 and/or network resources 130. Example clients 110 include in-vehicle infotainment systems, smart televisions, medical systems, IoT devices, industrial devices, etc.

Network resources 130 may be web or “cloud” resources that offer various services used by the smart host 100 and/or client 110. For example, network resources 130 may include e-mail, calendar, contacts, media, messaging, social networking, media streaming, business-related, and/or other services. The services may typically be hosted by third-party providers on their own infrastructure. The services may include custom services offered by businesses and accessible only via a resource such as a private network or virtual private network (VPN).

The services may be associated with a resource such as an API that may be used to login, access data, receive services, and/or otherwise interact with network resources 130. The service might support API calls over the Internet connection using protocols based on representational state transfer (REST) or similar methods. The API usually requires a login into an account and then the service shares session information (e.g., a token) that may be used to access data and receive the services or data.

In some embodiments, services and/or data provided via network resources 130 may be accessed using one or more smart host applications that may be accessed by a resource such as the smart host resources 410.

A “service account” may be an account maintained either by a network resource 130 or a smart host application that may be accessed by a resource such as the smart host resources 410. Local and remote service accounts may be supported by the system. A local account may be accessed by a resource such as the smart host resources 410 via a smart host application. A remote account may be accessed directly through a network resource 130. The remote account may be accessed by a resource such as the smart host resources 410 and/or the client resources 450.

To support persistent interaction between a client 110 and a service endpoint such as a network resource 130, a resource such as smart host 100 and/or client 110 may establish a session. A session may be initiated based on an authentication event and may be terminated based on a session termination event. A session may be bound by use of a “session secret” that a resource such as the client applications and/or services 470 may present to the endpoint (e.g., network resource 130) in lieu of client authentication credentials. Session types may include, for example, login sessions, client sessions, indirect sessions, and/or other appropriate types of sessions.

A login session may be established by a resource such as the smart host resources 410 after account access permissions are received (e.g., from a user 140). The login session may authorize the smart host resources 410 to access a specific service account and establish the maximum allowed permissions. The duration of such a login session may typically be relatively long (e.g., a few days, a few months, or longer). The login session might need to be re-established if the companion application 420 is reinstalled, logins change, there is a period of inactivity, and/or under other appropriate conditions. The login sessions may use standard protocols and approaches whenever they are supported such as format identification for digital objects (FIDO), open authorization (OAuth), OpenID, etc. Such login session protocols may include both authentication and authorization functionality.

A client session may be established based on an existing login session. To establish a client session, an authorized client 110 and/or client application may request access to a specific service account. The request may be generated by a resource such as the client resources 450, and may be sent to a resource such as the smart host resources 410. The smart host resources 410 may, in turn, request that temporary access be given to the service account. The access may be associated with more restricted permissions than those given to the login sessions.

The client session may be relatively short. The client session may be active only while the smart host 100 is connected to the client 110, for instance. As another example, the client session may last for a predefined client 110 usage duration. For example, the client session might require the smart host 100 at the session start but allow the client session to continue even if the smart host 100 is unavailable while the client 110 has not been turned off or logged off. Client session duration (and/or other client session attributes) may be controlled by the permissions and a resource such as the smart host resources 410, which may be controlled by the end-user 140 via a resource such as the companion application 420. The smart host resources 410 may typically end the client session automatically if the smart host 100 is disconnected form the client 110, after certain period of inactivity, and/or based on other relevant criteria. The client session may also be explicitly terminated by the end-user 140 via a resource such as the companion application 420.

An indirect session may be a type of client session that may be established by the smart host resources 410 based on a client session request received from the client resources 450. The smart host resources 410 may not publish the session secret received from the account provider (e.g., network resources 130, or a smart host application 440), and may create a new special session secret that may be sent to the client SDK. Whenever the client applications 470 or client resources 450 request data for an indirect session, the smart host resources 410 may redirect the call to the account provider passing the correct session secret. Such indirect sessions thus offer an extra level of protection of the secret credentials.

A session secret may a digital record, file, or document that identifies a given session. Some elements of the session secret may be understandable by various software components, while other elements of the session secret may be opaque. A session secret may include one or more tokens that provide access to specific resources provided for a given service account. The session secret may be stored securely and exchanged over a secure connection.

In some embodiments, the smart host resources 410 may act as a data service to the client 110. For instance, when the client resources 450 and client applications 470 do not (or are not able to) access the network resources 130 directly, but through the smart host 100. Such data services may include serving data (e.g., contacts, messages, calendar, events, etc.), executing permitted service functions (e.g., adding, removing, and/or editing records, calling other services or functions, generating and/or sending notifications, etc.), and/or other appropriate services. The data service enables powerful use cases that access data that may be not available through the cloud via resources such as APIs provided via the smart host 100. Clients 110 that are not connected to the Internet may access cloud services and data via the smart host 100.

The smart host 100 may expose one or more data services. Each data service in turn may publish one or more resources. A resource may be a service, data element or collection that may be accessible by other components, systems, devices, etc. A resource may be presented by one or more services and may be uniquely identified (e.g., using a uniform resource identifier (URI)). A resource may support actions performed on the resource, such as query, read, write, execute, notify, etc. The system may restrict access permissions to a given resource based on various relevant factors.

A connection token may be a string that identifies a connection between two devices (a host and peer) as seen by the host. The connection token may be based on a connection method, connection session, and/or other independent identifying information (e.g., media access control (MAC) address, BT address, device name or other identifier, etc.) that uniquely identifies the connection. The connection token should remain the same for the same two devices that use the same connection method. If a hard reset is performed or an application is uninstalled, a new connection token may be established. The connection token may include a randomly generated number (e.g., base64 encoded) that the host may look up based on information related the connected device (peer) that the host may “detect” independently, such as connection method, MAC or BT address of the detected device, etc.

In order to generate a certificate that may be unique for a specific combination of two devices, a combined connection token may be used. The combined connection token may be formed by the individual connection tokens as presented by each device. An example format of a combined token may be similar to: <Client Connection Token>|<Server Connection Token>, where the combined connection token may be used to generate certificates generated in various modes.

The combined connection token may include information that each device may identify and information that was received by the peer. This way, a combined connection token cannot be reused across multiple devices and connections. For example, if a given smart host 100 (with a given BT address) is connected and successfully authenticated with a client 110, a combined connection token may be constructed from the connection token generated by the smart host 100 and the client 110. A certificate may be generated for that combined connection token. If another smart host 100 is connected to the same client 110, a new connection token will be generated on the client side (as the BT address will be different). If the BT address on the smart host 100 is modified to match the original smart host 100, the combined connection token will still be different, unless the new smart host 100 also copies the connection token from the original smart host 100. In this case of matching connection tokens, the client 110 will authenticate the connection (as from client point of view the smart host may be exactly the same as the original). However, the same “hacked” Smart host cannot be used with a different client 110, as the client connection token stored on the client 110 will not exist or will be different. This way, mass hacking may be much more difficult.

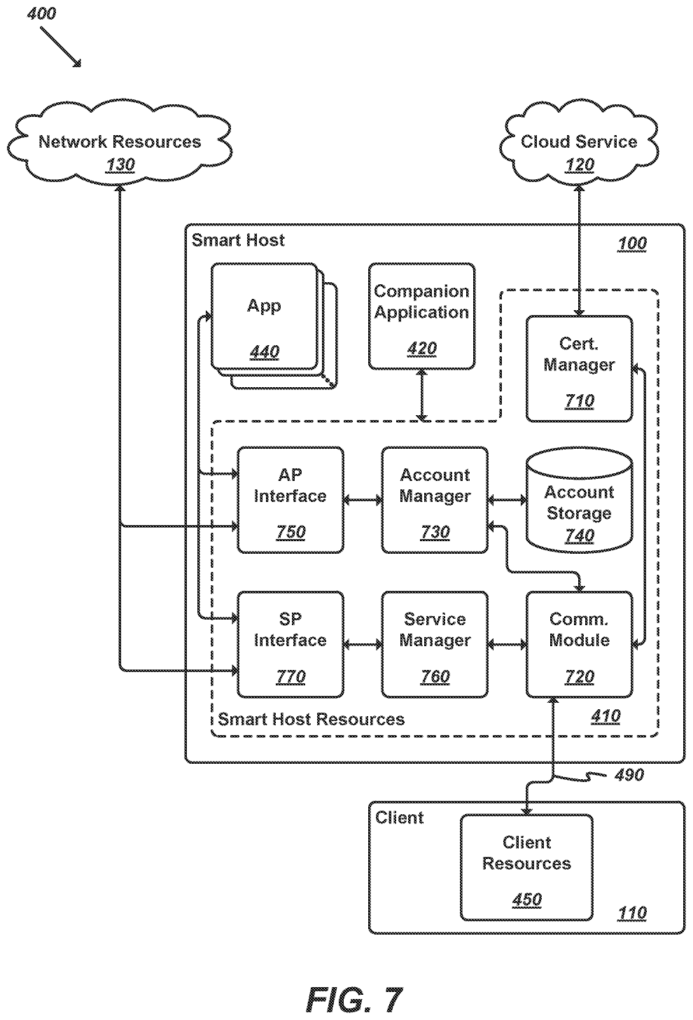

Smart host resources 410 will be described in more detail in reference to FIG. 7 below. Returning to FIG. 4, smart host resources 410 may include and/or be provided via the smart host SDK. Smart host resources 410 may communicate with other applications running on the smart host 100. The smart host resources 410 may run on the smart host 100 as part of the companion application 420 or as a system process as part of the smart host operating system (OS).

The smart host resources 410 may include components written in C, C++, Java, Kotlin, Swift, Objective-C, or other appropriate programming languages. A C/C++ implementation may be recommended, as the implementation may be ported and integrated to the various mobile and embedded platforms. Smart host resources 410 may be provided via a smart host SDK that allows third party developers to integrate the smart host resources 410 into their systems. Smart host resources 410 may include software libraries, example code and documentation, and/or other appropriate elements. This way existing companion applications may be integrated with the smart host resources 410. Smart host resources 410 may communicate with the cloud service 120 to obtain security certificates.

The Smart host resources 410 may communicate with the client resources 450 over one of the supported local connection channels using a client to smart host protocol of some embodiments.

Companion application 420 may be a dedicated application that integrates with the smart host resources 410. In some embodiments, the companion application 420 may include, or implement, some or all of the features associated with smart host resources 410. The smart host resources 410 may, in some embodiments, be integrated at the system level of the smart host 100, for example, into a system driver, system application or system library as part of the smart host OS. For generic smart hosts (e.g., smartphones) the companion application 420 may be an application that the end-user 140 installs. The companion application 420 may include Java, C/C++, Objective-C, Swift, Kotlin, and/or other appropriate programming languages or technologies. The companion application 420 may integrate with the smart host resources 410.

The companion application 420 may provide UI features to the user in order to manage accounts and services to be accessible for each authorized client 110. The companion application 420 may require biometric and/or other authentication information received from the user 140 to access services (e.g., all, none, or specific services). The authentication might be performed the first time or every time the smart host 100 connects to the client 110.

The companion application 420 may provide user notifications about various status changes regarding the client connection or account access. For example, notifications may be displayed whenever the client 110 is connected, is disconnected, account(s) are enabled, account(s) are disabled, specific services are accessed, session is disconnected, sensitive data is accessed or attempted to be accessed, etc.

Smart host OS 430 may be the host OS for the smart host 100 (e.g., Android OS, iOS, and/or another appropriate OS). The smart host resources 410 may use the infrastructure provided by the smart host OS 430 to access built-in services. For example, for Android the smart host resources 410 may use a built-in service to access the contacts on the smart host 100. Similarly, the smart host resources 410 may access other enabled services as permitted by the user 140. The smart host resources 410 may use any secure storage capabilities offered by the smart device OS 430 in order to store certificates, account information, etc.

Each smart host application 440 may be an application that runs on the smart host 100. Smart host applications 440 may access local data at the smart host 100 and/or data provided via network resources 130. Smart host applications 440 may provide APIs to the smart host resources 410 to obtain login information, access service data, and/or execute functions. Such APIs may be provided as part of the smart host OS 430 infrastructure. For example, on Android information may be shared using Intents or other inter-process communication methods. For iOS, information may be shared using message passing via URLs, application extensions, sockets, etc.

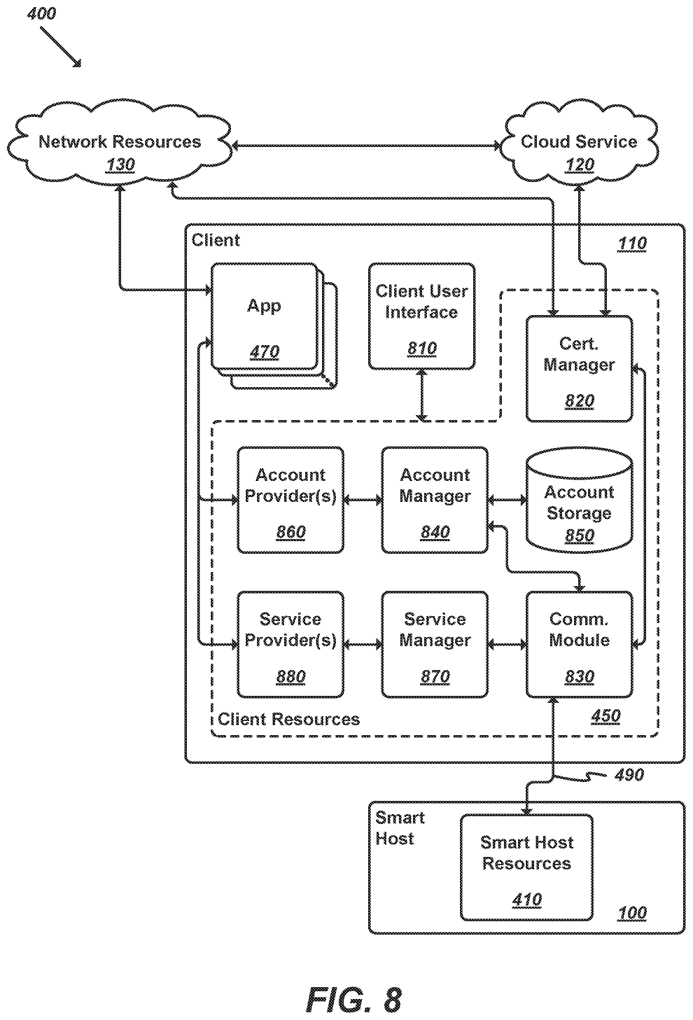

Client resources 450 are described in more detail in reference to FIG. 8 below. Returning to FIG. 4, client 110 may run client resources 450, which may include the client SDK. Client resources 450 may communicate with the smart host resources 410 over the local connection 490. Client resources 450 may be integrated into a standalone process or be part of the client OS 460. Client resources 450 may include C, C++, Java, and/or other appropriate programming languages. A C/C++ implementation may be recommended, as such an implementation may be ported and integrated to various embedded platforms. The client resources 450 may include software libraries, example code, and/or documentation.

The client resources 450 may communicate with the smart host resources 410 over the supported channels of local connection 490. The client resources 450 may receive service account information and manages the information locally. The client resources 450 may provide account access and/or service data access to the authorized client applications 470.

Client OS 460 may be an OS such as Android, Linux, Windows, QNX, etc. or may be a custom OS. Client resources 450 may use infrastructure provided by the client OS 470 such as identity management, profile management, security storage, etc. If such infrastructure is not provided by the client OS 460, the information may be included as part of the client resources 450.

Each application and/or service 470 may run on the client 110 (e.g., using processing and storage resources of the client 110). Each application and/or service 470 may access account information from the smart host 100 via the client resources 450 and access the network resources 130 directly or indirectly via the smart host 100. Client applications 470 may include any standalone processes, applications, built-in services, and/or other software modules that require access to account information and/or cloud service data. The client applications 470 may receive only access information from the smart host 100 and obtain data and services via the network resources 130, or data and services may be accessed via the smart host 100.

Network interface 480 may provide connectivity to resources such as the Internet. Network interface 480 may be able to communicate or otherwise send and/or receive data via one or more networks, such as cellular networks, Wi-Fi networks, distributed networks, the Internet, etc.

Local connection 490 may include, utilize, provide, and/or otherwise support various connectivity channels. Examples of supported connectivity channels include USB, BT, BT low Energy (BLE), Wi-Fi, UWB, NFC etc. Such channels typically provide infrastructure to establish generic serial communication between two parties. The communication may be secure and/or authenticated or not. On top of the established connection, the system of some embodiments may include client to smart host protocols that include the necessary message packaging, addressing, and secure communication features that allow communication between the smart host 100 and client 110.

The establishment of a local connection 490 may indicate that a proximity threshold between the smart host 100 and client 110 is satisfied (e.g., indicating that a user 140 is within a specified radius of the client 110). For instance, a BT connection may be limited to a range on the order of thirty feet. Other local connection channels may be similarly limited to a particular proximity threshold.

In addition to data communication, the system may use other identification technologies such as radio-frequency identification (RFID), BLE, UWB, NFC, and/or similar technologies to identify that the smart host 100 is near the client 110 to provide an extra level of authentication. This way, for example, basic authentication for profile switching may be performed without the need to establish serial communication with the smart host 100.

Various protocols and data records may be used by the system to communicate between sub-systems, store data, and/or perform other system functions. For instance, client to smart host protocols may be used by the smart host resources 410 to communicate with the client resources 450 over local connection 490. The system may use a layered protocol approach, where separate protocols that handle different aspects of the communication are wrapped or layered on top of each other.

One example protocol that may run on top of the local connection 490 may be a peer to peer (P2P) protocol that encapsulates higher-level data into packets that are sent between two peers (e.g., the smart host resources 410 and the client resources 450). The P2P protocol may be implemented using a standard protocol such as serial line Internet protocol (SLIP) or other similar standard or custom protocols.

On top of the P2P protocol, for example, the system may provide an end-to-end data communication protocol specifying how data should be packetized, addressed, transmitted, routed, and received. The end-to-end data communication protocol may be implemented using a standard protocol such as TCP/IP or custom similar protocol.

As an example, a session protocol may include messages exchanged between smart host resources 410 and client resources 450 to begin or end a login session or client session. The session protocol may include, for instance, a client account request message, a client account response message, a client session request message, a client session response message, an end client session request message, and an end client session response message.

The client account request message may include elements such as a request identifier, service type identifier, client application identifier, client application authentication record, and a list of requested permissions. Throughout this disclosure, the term “identifier” may be used to refer to a unique identifier associated with a specific device or component. The term “type identifier” may be used to refer to a unique identifier associated with a type that may include or be associated with multiple distinct devices or components.

The client account response message may include elements such as the request identifier of the corresponding client account request message, a response code (e.g., “success” or type of error), error message(s), the service type identifier, the client application identifier, a service account identifier (if successful, representing the account for which the client application was authorized), and a client application account authorization (e.g., a client application account authorization record that includes permissions given to the requesting application to access the specified service account).

The client session request message may include a request identifier, a service account identifier associated with the account for which the client sessions should be started, a service type identifier that identifies the service type that is requested by the client application, a client application identifier, a client session authentication record that may be used to identify the application to the smart device resources 410 or the service to access the given service account for the requested client session, a request permissions element that may include permissions requested by the client for the session, and a previous session secret that may include the session secret from a previously started client session (if any).

The client session response message may include elements such as the identifier of the corresponding client session request message, a response code (e.g., indicating success or type of error), an error message (if any), a service account identifier, the client application identifier provided in the corresponding client session request message, and a session secret that may include information to be used by the client 110 to access network resources 130 or to access smart host services via smart host resources 410.

The end client session request message may include elements such as a request identifier and a session secret for the client session to be ended.

The end client session response message may include the request identifier of the corresponding end client session request message, a response code (e.g., indicating success or type of error), and error message (if any).

When the smart host 100 acts as a data server to a client 110, the smart host 100 may support different protocols depending on the service type. Even for the same type of service there may be multiple supported protocols, based on the providers. In many cases, the protocols may follow internet accepted standards of request/response, client/server, etc. Standard protocols such as IMAP, POP3 for e-mails, CalDAV for calendars, CardDAV for contacts information, etc. may be utilized.

In cases where there is no accepted standard, the system may use a custom protocol based on HTTPS, REST API paradigm, direct sockets, and/or remote procedure calls (RPC) calls (e.g., gRPC) using JavaScript object notation (JSON), protocol buffers or other payload formats. The specific custom protocols may be easily defined using any of the formats and methods described above as a reference.

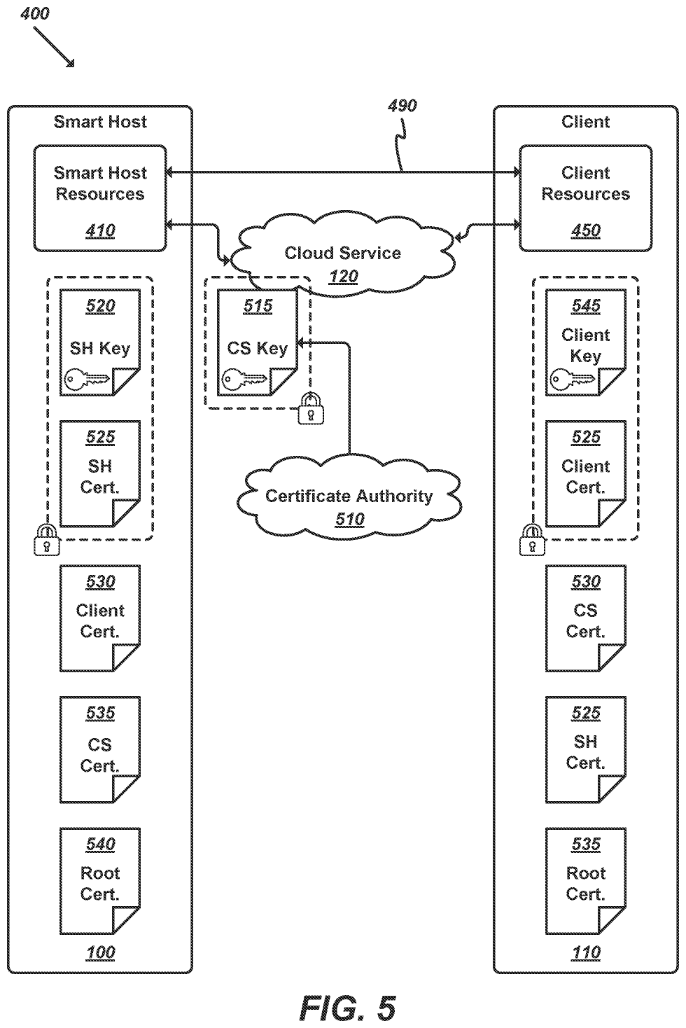

FIG. 5 illustrates a schematic block diagram of a portion of an environment 400 of one or more embodiments described herein, in which security keys and certificates are shared between smart host 100 and client 110. As shown, cloud service 120 may interact with certificate authority 510 and may include cloud service key 515 to cloud service 120. Smart host 100 may include smart host key 520, smart host certificate 545, client certificate 530, cloud service certificate 535, and root certificate 540. Client 110 may include client key 545, client certificate 530, cloud service certificate 535, smart host certificate 525, and root certificate 540.

Certificate authority 510 may be provided by (and/or accessed by) cloud service 120. Certificate authority 510 may manage security certificates associated with the smart host 100 and/or client 110. The certificate authority 510 may be the anchor authority that issues the root digital certificate 540 and signs the cloud service certificate 535. The certificate authority 510 may be a resource such as a third party trusted certificate authority (e.g., GlobalSign) that may issue intermediate certificates, a self-hosted private public key infrastructure (PM) hosted by a client device provider, a managed PM hosted by a trusted third-party provider, and/or other appropriate resource(s).

Cloud service key 515 may be a private key used by cloud service 120 to sign various certificates used by the system. Smart host key 520 may be a private key used by smart host 100 to sign various certificates used by the system. Such private keys are not shared with other system components and may be stored locally and/or otherwise protected.

Client certificate 530 may be a digital certificate to identify clients 110 that are certified to be part of the proposed system. The private key 545 for the client certificate 530 may be stored securely on the client 110 in a secure storage. The secure storage may be part of the client resources 450, may utilize infrastructure provided by the client OS 460, may be stored in a resource such as a hardware security module (HSM), etc.

The public key client certificate 530 may be stored on the client 110 and passed to the smart host resources 410. The public client certificate 530 may be stored on cloud service 120.

Cloud service certificate 535 may be a certificate associated with cloud service 120 that may be used to verify the signature of the client certificate 530 and/or smart host certificate 525. The private key 515 for the cloud service certificate 535 may be stored securely at the cloud service 120. The public key cloud service certificate 535 may be distributed to the smart host 100 and client 110.

Root certificate 540 may be a digital certificate issued by a resource such as certificate authority 510, and/or other root certificate authorities (e.g., those provided via online resources such as servers, APIs, etc.), that may be stored by peer devices to verify the identity of the cloud service certificate 535 and create the “chain of trust”.

Client key 545 may be a private key used by client 110 to sign various certificate used by the system.

Smart host certificate 525 may be a digital certificate that identifies a specific smart host resources 410 instance and corresponding connection to a specific client resources 450 instance. The private smart host key 520 may be stored securely at the smart host 100 using a custom data store or any of the secure stores provided via the smart host OS 430 API. For example, for iOS, the secure storage may be the Keychain Services and for Android may be the Keystore API. The public key smart host certificate 525 may be sent to the client resources 450. The smart host certificate 525 may be stored at the cloud service 120.

Some of the authentication modes may require certificates to be pre-installed or downloaded from the certificate authority 510 (e.g., via cloud service 120). For some authentication modes, the client 110 needs to have a client certificate 530 that has been signed by the certificate authority 510.

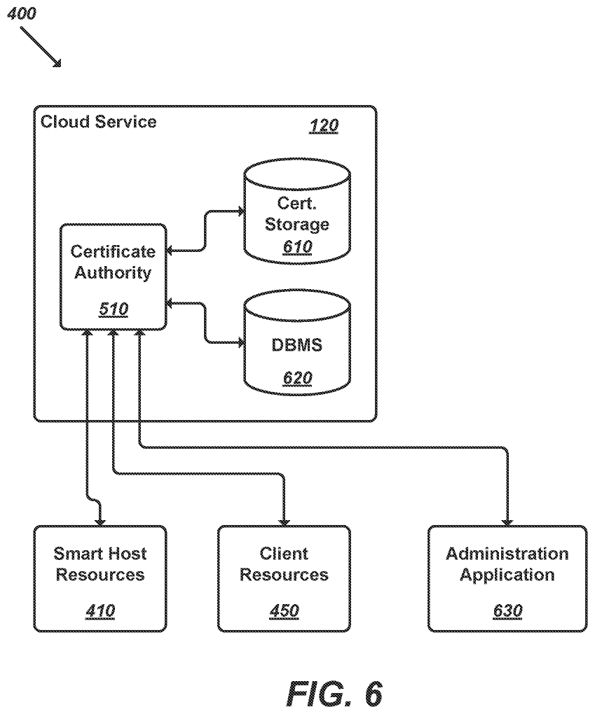

FIG. 6 illustrates a schematic block diagram of a portion of an environment 400 of one or more embodiments described herein, including elements of a cloud service 120. As shown, cloud service 120 may include certificate authority 510, certificate storage 610, and database management service (DBMS) 620. Cloud service 120 may interact with smart host resources 410, client resources 450, and/or administration application 630 (e.g., via a resource such as certificate authority 510).

Cloud service 120 may be accessed by the smart host resources 410 and/or client resources 450. Cloud service 120 may offer certification and authorization services. Cloud service 120 may be deployed to a private cluster managed by some entity or be deployed to a public cloud resource such as AWS, Google Cloud, Azure, etc.

Individual services may be implemented using standard web development techniques. For example, web application frameworks such as Java enterprise edition (JavaEE), EJB, Spring, NodeJS, etc. may be used to implement cloud service 120. Cloud service 120 may be deployed using serverless infrastructure provided by a Cloud provider such as AWS, Google Cloud, Azure, etc. For example, service handlers may be implemented as AWS Lambda functions, storage using AWS S3, database as AWS DynamoDB, etc.

Modules may be implemented as microservices that implement portions of the public protocol exposed by the cloud service 120 that may be accessed by the various clients 110, applications and/or services 470, and/or other resources.

Certificate authority 510 may issue digital certificates to the smart host resources 410 and the client resources 450. Certificate authority 510 may be implemented at cloud service 120. A digital certificate certifies the ownership of a public key by the named subject of the certificate. This approach allows others (relying parties) to rely upon signatures or on assertions made about the private key that corresponds to a certified public key. A certificate authority, such as certificate authority 510 may act as a trusted third party that is trusted by both the subject (or owner) of the certificate and by the party relying upon the certificate. The certificate authority 510 may use standard certificate formats such as X.509, EMV, etc. and/or custom implementations. Certificate authority 510 may store the requested, issued, and revoked certificates in the certificate storage 610. Certificate authority 510 may store transaction information in the DBMS 620 for audit purposes.

Certificate storage 610 may store the certificates generated or revoked by the certificate authority 510. The information may be stored in a relational database such as Postgres or non-SQL database such as Mongo DB. The records may be encrypted and/or compressed. The system may use a hardware cryptomodule to store keys and/or perform digital signing.

DBMS 620 may be a general-purpose database that may be used by the other modules in the system to store data such as audit logs, account information, etc. The DBMS 620 may be implemented using a relational database such as Postgres or non-SQL database such as Mongo DB, a custom database, etc. The records may be encrypted and/or compressed.

Administration application 630 may be a portal application that may be used to manage the cloud service 120. Such management may include management of user accounts, certificates (e.g., provisioning, revocation, etc.), etc. Administration application 630 may be accessed over a secure connection and may utilize additional VPN features for protection. The administration application 630 may run on a web browser, desktop, mobile device, etc.

FIG. 7 illustrates a schematic block diagram of a portion of an environment 400 of one or more embodiments described herein, including elements of a smart host 120. As shown, smart host 100 may include companion application 420, applications 440, and a set of smart host resources 410 that may include certification manager 710, communication module 720, account manager 730, account storage 740, account provider interface 750, service manager 760, and/or service provider interface 770.

Certification manager 710 may implement certificate management for the smart host resources 410. The certification manager 710 may be used by the communication module 720 to authenticate the client 110 and establish a secure local connection 490. Certificate manager 710 may work with bundled certificates, download updated certificates from the cloud service 120, manage revoked certificates, and store certificates securely either in a custom secure storage or any of the infrastructure provided by the smart host OS 430.

Communication module 720 may be responsible for higher-level communication with the client resources 450 over one of the channels associated with local connection 490. Communication module 720 may authenticate connected clients 110. After the client 110 has been authenticated, the communication module 720 may facilitate message exchange with the other components in the smart host resources 410. Example messages are described in reference to the client to smart host protocol. Communication module 720 may perform buffering, initial message validation, timeout handling, retries, etc. Communication module 720 may implement various algorithms for message handling using queues, acknowledgement (ACK), or other similar solutions. Whenever a message cannot be delivered, communication module 720 may notify the caller. Communication module 720 may attempt to reestablish a link with the client 110 and resend any pending messages.

Communication module 720 may be able to interact with various other smart host systems or components and may be able to at least partly direct operations of such systems and components. For instance, communication module 720 may communicate with smart host OS 430. As another example, if the smart host 100 is associated with a smartphone, for instance, communication module 720 may be able to communicate with various smartphone systems, such as positioning system or components (e.g., global positioning system (GPS) components), communication components (e.g., a cellular transceiver), etc.

Account manager 730 may manage all service accounts (whether local or remote) that may be exposed to the client resources 450. The individual service accounts may be prepared and managed by the account provider interface 750. The account manager 730 may aggregate the account information from the various providers into a unified data structure and store the account information securely in the account storage 740. The account manager 730 may include a resource such as a client account manager (not shown) that may access account information to be shared with the client 110.

The client account manager may be responsible for handling the status and authorization for service account access for clients 110. The actual account login and sessions may be started by the account manager 730. The client account manager may manage which client(s) 110 (as identified by a unique client identifier) and/or which client application(s) (as identified by a unique client application identifier) may access which account(s) and which service(s) from the service manager 760. The client account manager may monitor the authorized client applications 470 and any active client sessions through a dedicated client application account storage and/or other appropriate resources.

The client account manager may handle any message requests from the client resources 450 received via communication module 720. The client account manager may rely on the communication module 720 to authenticate the client 110 The client account manager may authenticate each calling application. When a client session is requested, the client account manager, based on the account permissions, may create an indirect session and return a session token to the client 110.

Account storage 740 may store the account information that may be managed by the account manager 730. Account storage 740 may be implemented using relational database (e.g., SQLite), non-relational database, file storage, custom database, secure storage provided via smart host OS 430 (e.g., Android KeyStore, iOS Data Protection, etc.), HSM, etc. The records stored at account storage 740 may be encrypted and/or digitally signed using any state-of-the-art digital signature resources. The records may be compressed to reduce storage requirements. Whenever possible, the account storage 740 should utilize any secure data storage and sandboxing protection schemas provided by the smart host OS 430.

A client application account storage (not shown) may be similar to account storage 740 and may store account and session information that may be managed by the client account manager. The client application account storage may be implemented using relational database (e.g., SQLite), non-relational database, file storage, custom database, secure storage provided via smart host OS 430 (e.g., Android KeyStore, iOS Data Protection, etc.), HSM, etc. The records stored at the client application account storage may be encrypted and/or digitally signed using any state-of-the-art digital signature resources. The records may be compressed to reduce storage requirements. Whenever possible, the client application account storage should utilize any secure data storage and sandboxing protection schemas provided by the smart host OS 430.

Account provider interface 750 may be, include, and/or otherwise implement an abstract programming interface used to manage different account types from different account providers such as local smart host applications 440 or remote network resources 130. The account provider interface 750 may unify the various types of functions and methods that may be used to login, logout, start and/or end sessions, etc. among the various account providers. The different types and/or formats of data exchanged with the account providers may be abstracted under the common account provider interface 750. The account provider interface may include local account providers and remote account providers.

The account provider interface 750 may expose functionality such as account login management and/or client session management to the account manager 730. Account login management may provide various functions to manage the account login session at the smart host resources 410. Successful login may be required to be able to start a client session. Account login management may include functions as login, logout, login status, etc.

The login function may be used to start a login session. The caller may provide any stored login cryptomaterials such as username, password, certificate, tokens, PIN, etc. and, if successful, the associated account provider may return a login session secret. As part of the login process, permissions, a login secret, and/or other information may be received from a user 140. A user 140 may be required to perform authentication using biometric or other methods. The logout function may be used to log out the smart host resources 410 from a given account and/or otherwise terminate a login session. The login status function may return a current login session status (e.g., if logged in, if logged out, timed-out, etc.).

Client session management may provide various functions to manage the client session for a given service account and client 110. A client session may be started and/or stopped only after a login session is successfully established. Client session management may include functions such as start session, renew session, end session, and session status.

The start session function may start a new client session for the given service account and a connected client 110 or requesting client application 470. The client account manager may have already authenticated the client 110. However, the account might require client-specific cryptomaterials such as a certificate, tokens, PIN, etc. that may be passed to the start session function. If successful, the account provider may return a client session secret that may be passed to the client 110 or be used by the service providers during provision of smart host services when the smart host 100 acts as a data server. As part of the start session process, permissions, a login secret, and/or other information may be received from a user 140. A user 140 may be required to perform authentication using biometric or other methods. A renew session function may renew a previously started client session. Such renewal might be needed in cases where the client session has expired or is close to expiring. An end session function may end a previously started client session. As input, the end session function may receive the client session secret of the previously started session. A session status function may return the status of any client session(s) (e.g., started, ended, expired, etc.).

There may be different types or implementations of the account provider interface 750. Some may be associated with remote account providers, which access network resources 130 directly to manage login and client sessions. Others may be associated with local account providers, which communicate with smart host applications 440 to manage login and client sessions.

Account provider interface 750 may utilize protocols such as OAuth, Open ID, or others to login into the remote provider accounts, start new sessions, and/or otherwise interact with the network resources 130 via the remote account providers. In some embodiments, account provider interface 750 may use custom service provider specific protocols to manage sessions. Account provider interface 750 may communicate with one or more network resources 130 to manage login and/or client sessions. Individual provider components may store account provider-specific information such as tokens or certificates in the account storage 740 to be used to manage the sessions.

Account provider interface 750 may include, utilize, and/or otherwise implement local account providers such as smart host applications 440 or the smart host OS 430 to manage login and client sessions for data stored locally or remotely.

For example, to provide access to the contacts enabled on a smart host 100, the account provider interface 750 may use the contacts API of the smart host OS 430. For example, for Android OS this may be the ContactsContract API. When a login operation is requested, an account provider component may request the necessary permissions (e.g., android.Manifest.permission.READ_CONTACTS) from the user 140. If successful, the account provider may generate a pseudo login session secret that may be returned to the caller and be used to validate the other requests. Similarly, the account provider may generate pseudo session secrets for the requested client sessions. Internally the account provider may share the login information with a corresponding service data provider that may read the contacts information.

In a similar fashion other service accounts may be supported. Many third-party smart host applications 440 may offer APIs for authorized apps to login or obtain data. Such login or data retrieval may be typically done using custom protocols published by the application providers. For each such application, there may be a corresponding local account provider that supports the protocol and performs the session management functions. The local account provider may work with a corresponding service data provider that is able to retrieve the needed data and perform the requested service functions.

Service manager 760 may manage data services available from the local and/or remote service accounts and provided via the smart host resources 410. The data services may be accessed by client resources 450 and/or the client applications 470. The individual services may be managed using individual service providers. The service manager 760 may manage the individual service providers and associated permissions. Individual service providers may work with the corresponding account providers that manage the login and client sessions. When a request is received from the client 110, the service manager 760 may perform initial validation of the caller and check permissions. The service manager 760 may then pass the actual request handling to the correct service provider.

Service provider interface 770 may be similar to account provider interface 750 and may provide a unified interface to the various service provided by local smart host applications 440 and/or network resources 130. The service provider interface 770 may be used by the service manager 760 to provision, start and forward requests to the client 110 for the correct service provider. The actual service data requests may be performed using the protocols associated with the smart host services.

Service provider interface 770 may include ways to query endpoints and permissions. Endpoints may define one or more end points that may be used to query, retrieve, or execute certain functionality by an associated service provider. The endpoint may be typically defined using a URI or some other locator addressing. Multiple endpoints may be provided by the same service provider associated with the same or different services. Any requests to resources within the endpoints published by the service provider are routed to that service provider. Permissions may define the general permissions for the published endpoints. Permissions may be specified in the form of resource access permission records.

There may be a variety of service types supported by the system. Each service type may support one or more protocols to be used by the client 110 to access the service. To make the system more universal and independent of the actual local or remote service providers, the system may support translating service providers. Translating service providers may handle the requests from the client 110 and redirect the calls to the correct service provider that interacts with the actual local or remote resource.

Remote service providers may communicate with one or more network resources 130 to retrieve data, send notifications, and/or execute requests. Remote service data providers may use standard protocols such as, for example, IMAP, POP3, SMTP for email, CalDAV, iCalendar for calendars, CardDAV for contacts, SIP for messaging, etc., or may use custom protocol implemented by the specific cloud service. The remote service provider may obtain an access token from the corresponding account provider.

Local service providers may communicate with one or more smart host applications 440 or the smart host OS 430 to access smart host services. There may be one service provider for each type of service. The local service provider may obtain the access token and the authorizations for the caller from the corresponding account provider component.

For example, to provide access to the contacts enabled on the smart host 100, there may be a service provider that uses the contacts API of the smart host OS 430. For example, for Android OS this may be the ContactsContract API. When contacts are requested by the client 110, the corresponding service data provider component may be invoked, which in turn may call the ContactsContract API to retrieve the requested contacts data

In a similar fashion, any type of service may be supported as long as there is a smart host application 440 or system component that provides an API to the smart host resources 410 to access the service data and/or request service actions.

FIG. 8 illustrates a schematic block diagram of a portion of an environment 400 of one or more embodiments described herein, including elements of a client 110. As shown, client 110 may include applications 470, client UI 810, and a set of client resources 450 that may include certification manager 820, communication module 830, account manager 840, account storage 850, account provider(s) 860, service manager 870, and/or service provider(s) 880.

UI 810 may be similar to companion application 420 and may allow a user 140 to interact with the client resources 450 in various ways. For instance, UI 810 may allow user selections to be received. As another example, UI 810 may provide messages to a user 140.

Certification manager 820 may implement certificate management for the client resources 450. Certification manager 820 may be used by the communication module 830 to authenticate the smart host 100 and establish a secure local connection 490.

The certification manager 820 may bundle certificates, download updated certificates from the cloud service 120, manage revoked certificates, store certificates securely either in a custom secure storage or any of the infrastructure provided by the client OS 460, and/or otherwise manage certificates and/or other authentication information.

Communication module 830 may be responsible for the higher-level communication with the smart host resources 410 over one of the channels of local connection 490. Communication module 830 may be responsible for authenticating the connected smart host 100. After the smart host 100 has been authenticated, communication module 830 may facilitate the message exchange with the other components of the client resources 450.

Example messages are described in reference to the client to smart host protocol. The communication module 830 may be responsible for buffering, initial message validation, timeout handling, retries, etc. The communication module 830 may implement various algorithms for message handling using queues, ACK, or other similar solutions. Whenever a message cannot be delivered, communication module 830 may notify the caller. Communication module 830 might try to reestablish a link with the smart host 100 and resend any pending messages.

Communication module 830 may be able to interact with various other client systems or components and may be able to at least partly direct operations of such systems and components. For instance, communication module 830 may communicate with client OS 460. As another example, if the client 110 is associated with a vehicle, for instance, communication module 830 may be able to communicate with various vehicle systems, such as entertainment systems, transmission control systems, seat adjustment features, etc.

Account manager 840 may be responsible for managing all service accounts that are exposed to the client 110 by the smart host resources 410 and/or network resources 130 for a given profile. The individual accounts may be managed by separate client account provider components. The account manager 840 may be responsible for initializing the correct account provider component as a result of an application request and may store related information securely in a client account storage, which may be implemented as a sub-element of account storage 850.

The account storage 850 may be associated with an active profile and only be accessible if the profile manager has activated that profile. The account manager 840 may utilize infrastructure provided by the client OS 460 to manage accounts. For example, in Android the system may use the AccountManager API.

The profile manager may be a sub-element of account manager 840 that may manage individual user profiles on the client 110. The profile manager may create, remove, and/or edit user profiles associated with users 140. The profile manager may work with the communication module 830 to detect and identify the connected smart host 100 and, based on the identity, perform an automatic switch to the profile associated with the connected smart host 100. The profile manager may request further user authentication via the smart host 100 and/or client 110.

The profile manager may store profiles at a profile storage that may be similar to account storage 850. Profiles may be encrypted before being stored. When the smart host 100 is disconnected or manually logged-off from the client 110, the profile manager may discard the associated encryption key. This way the data may be accessed only when an authenticated smart host 100 provides the decryption key for the next session. The profile manager may work with an existing profile and/or user management resource if already provided by the client OS 460. For example, if the client 110 runs on Android, profile may be managed using the UserManager and DevicePolicyManager APIs. The profile manager may respond to requests from authorized smart host resources 410 or from the client applications 470 to clear any profile data.

A profile may be a complex data document (object or database) managed by the profile manager and stored at the profile storage. The profile may include settings, account information, cryptomaterial, cached data, and/or other appropriate information associated with an authorized user 140. Only authorized users 140 may access each profile. The profile may include settings and records from the other components associated with the client resources 450. The profile may include other user settings used by the client 110 and/or other systems or components. For example, UI settings such as brightness, default volume settings, etc., or settings for external components connected to the client 110. For example, for vehicles the profile may include personal preferences such as seat position, climate control settings, mirror positions, etc.

The profile storage may provide the storage infrastructure for the profiles that are managed by the profile manager. The profile storage may be a local database such as SQLite, non-SQL database, custom data storage, file-based storage system, hardware cryptographic module-based system, or an existing profile storage system supported by the client OS 460. Data in the profile storage may be encrypted and/or compressed.

In order to protect the profiles and the associated data, the profile manager may encrypt the profile data stored in the profile storage. Keys stored and protected on the client 110 may be used to encrypt the profiles. However, the data may be exposed to potential hacking. Another way of encrypting the data is to use rotating keys stored on the cloud service 120. Every time an authorized smart host 100 is connected to a client 110, the smart host 100 may pass two keys (the current key and the next key). The current key may be used to decrypt the current profile data and use the data for an active client session. When the session is terminated, the profile data may be re-encrypted with the next key. The keys may be discarded by the client 110 and the profile data may be decrypted only when the authorized smart host 100 connects and passes a new current and next key pair (in this case, the current key will match the previous next key). For further protection, encryption and/or decryption may utilize keys that are provided and stored only on the client 110 that are combined with the keys provided by the cloud service 120.

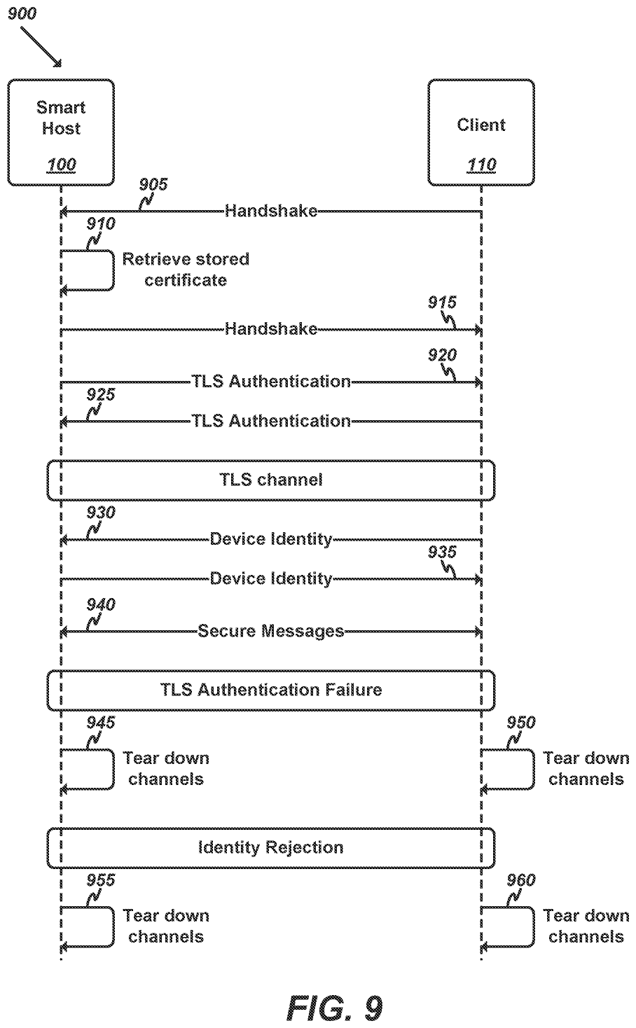

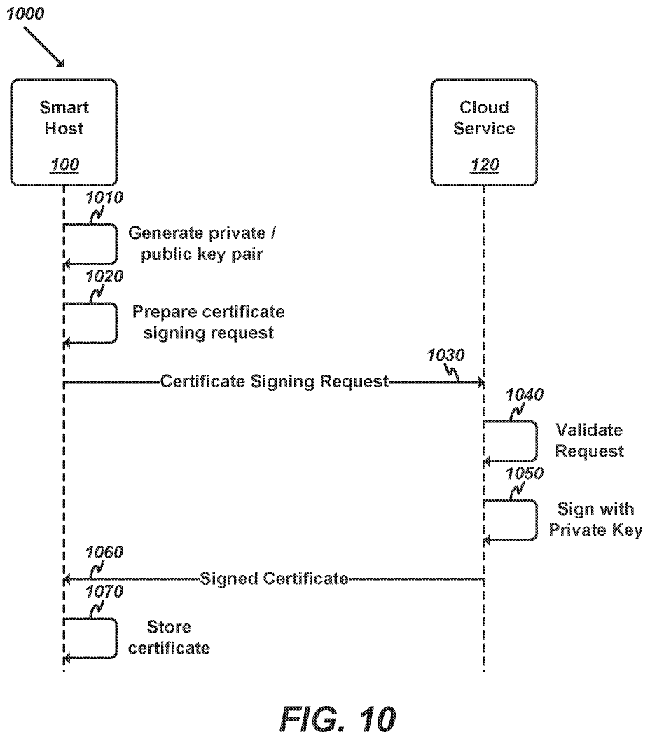

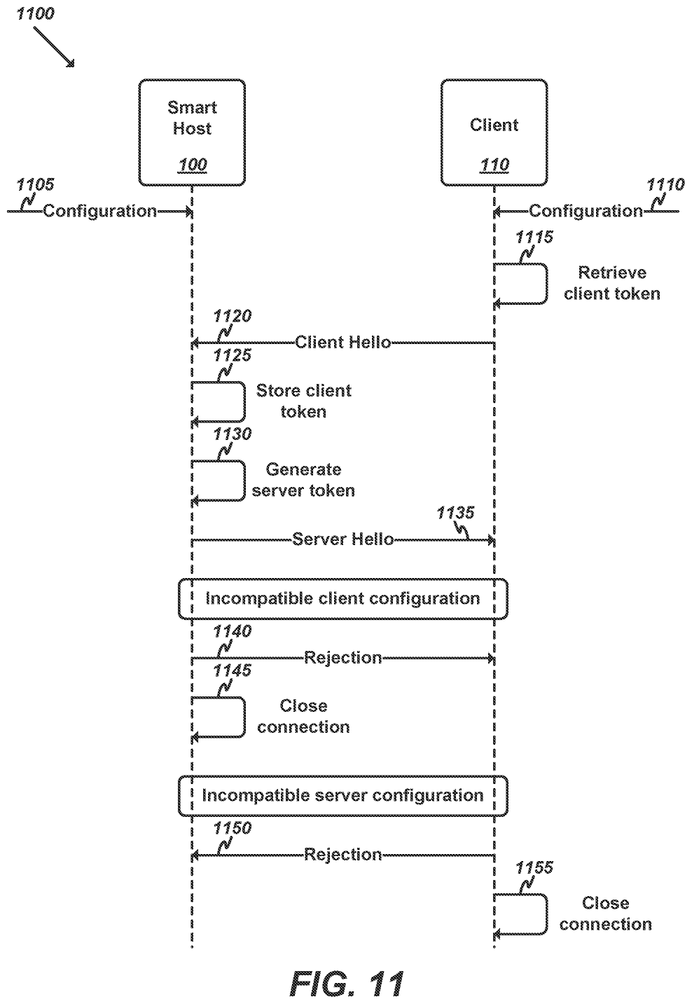

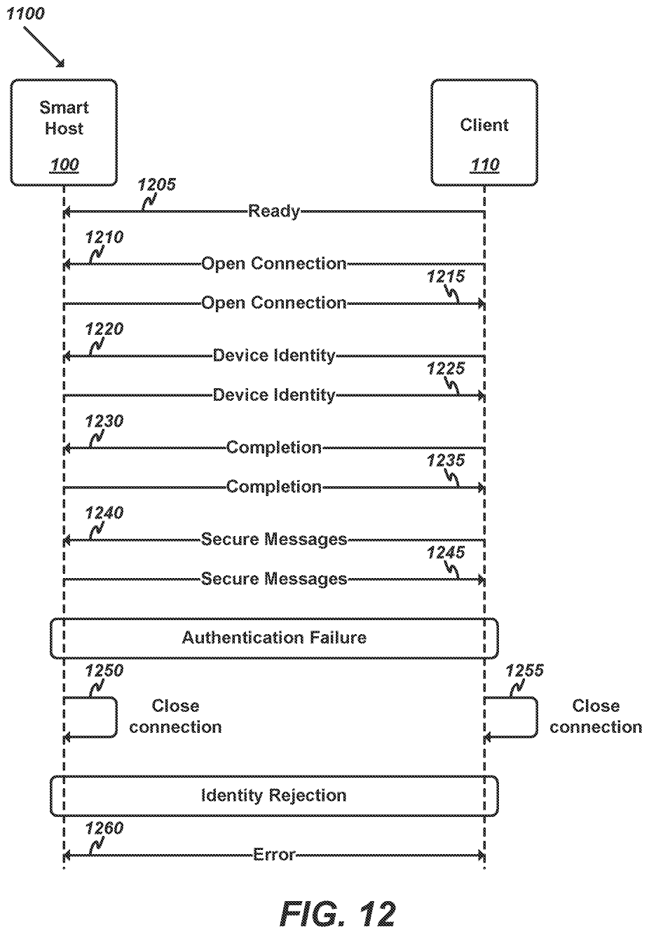

When the smart host 100 is connected to the client 110, the communication module 830 may authenticate the smart host 100 using an authentication protocol of some embodiments. The authentication protocol is described in more detail in reference to FIG. 9, FIG. 10, FIG. 11, and FIG. 12 below.

Returning to FIG. 8, using an identity message, the profile manager may receive the identifier of the profile to be activated. The identity message may include the current decryption key and the next encryption key as described above. With this information, the profile manager may activate the designated profile.

In some cases, the profile setting might require additional user authentication. Depending on the configuration, such authentication might be performed on the smart host 100 by a resource such as the companion application 420 (e.g., using a PIN, password, biometrics, etc.) and the authentication information may be passed as part of the authentication messages. The authentication may be performed on the client 110 using any supported method such as PIN, passwords, biometrics, etc.

Account storage 850 may store the account information that is managed by the client account manager sub-component of the account manager 840. The account storage 840 may be implemented using relational database (e.g., SQLite), non-relational database, file storage, custom database, secure storage provided by the client OS 460, HSM, etc. Account records may be encrypted and/or digitally signed using state-of-the-art digital signature resources. The records may be compressed to reduce storage requirements. Whenever possible, the storage should utilize any secure data storage and sandboxing protection schemas provided by the client OS 460.

Account providers 860 may be similar to account provider interface 750 and the associated account providers described above. Each account provider 860 may provide account access to a given service account type. There may be multiple account provider components 860, where each account provider 860 may be associated with a different service type. The account provider 860 may receive the session secret information from the account manager 840 and publishes the session secret information to the authorized client applications 470. The account providers 860 may use infrastructure provided by the client OS 460 to publish account information. For example, if the client OS 460 is Android, the system may use the Authenticator API to create a custom authenticator.

Service manager 870 may be similar to service manager 760 described above. Service providers 880 may be similar to service provider interface 770 and the associated service providers described above.

One of ordinary skill in the art will recognize that environment 400 may be implemented in various different ways without departing from the scope of the disclosure. For instance, environment 400 may include various other components, devices, systems, etc. than shown. As another example, environment 400 may include various other communication pathways (e.g., networks, local channels, etc.) than shown. In addition, the various devices or components may include additional, fewer, and/or otherwise differently configured sub-elements or sub-components.

The system may support various authentication modes. Several example authentication algorithms, sequences, and/or protocols are described in reference to FIG. 9, FIG. 10, FIG. 11, and FIG. 12. Resources such as smart host resources 410 and client resources 450 may configure the correct authentication modes for each party. The authentication and/or connection mode may change based on the status of a peer and/or other relevant criteria (e.g., availability of network connections, device capabilities, etc.).

Many examples herein may describe roles such as “server” and “client”. Depending on relevant configuration parameters, various resources, such as smart host resources 410, client resources 450, cloud service 120, network resources 130, etc. may act as a server or client under various operating conditions. As a default, the smart host 100 may be associated with the server role and the client 110 may be associated with the client role by the system of some embodiments.

In a self-signed certificate mode, the server (and potentially the client) may use self-signed certificates for authentication. Such a mode may only be enabled for debugging purposes. The other side may accept and “trusts” the self-signed peer certificate. Such a mode may be susceptible to man-in-the-middle attacks and may be disabled for consumer components (e.g., an error may be returned).

In a no client certificate mode, the system may not require a certificate on the client side. This mode may be set by the server side. Such a mode may implement a client-server transport layer security (TLS) connection, where the server does not authenticate the client. If a client requests the no client certificate mode, the server may return an error message. The smart host 100 may accept connections from any client 110 (e.g., a vehicle head-unit, shared entertainment system, etc.) in the no client certificate mode. There may be no need to provision clients with individual certificates. The server may require a valid certificate provided via another mode such as signed by a trusted certificate authority or connection token signed by a trusted certificate authority mode. Potential issues associated with the no client certification mode may include that the client 110 is not able to be authenticated. For example, if there are certain application features that should only be enabled for a specific client 110, there may be no way to validate that client 110.

In a peer-signed certificate mode, the peer device may sign the certificate, which may be provided securely using some other method (e.g., password authentication described below). In this mode, there is no need for a certificate authority and back-end infrastructure. Thus, the peer-signed certificate model may function without Internet connections. The peer-signed certificates are unique for each specific peer device, which reduces the risk of mass hacking (e.g., if one device is compromise, the associated certificate cannot be used to connect to other devices). Peer-signed certificate mode may be used in combination with the signed by a trusted certificate authority mode. For example, the client 110 may request from the smart host 100 a peer-signed certificate and the smart host 100 may request a signed by a trusted certificate authority certificate. The client 110 may include, for example, a cryptography module to protect the client key associated with the trusted-authority signed client certificate, such as client key 545 and client certificate 525. The smart host 100 may certify the client 110. The smart host 100 (which may be potentially hackable) may receive a certificate only for the specific client 110 using an initial password authentication algorithm described below. Potential issues associated with the peer-signed certificate mode may include that the peer device cannot be independently authenticated (e.g., the peer device does not provide a certificate signed by a trusted authority).

In the signed by a trusted certificate authority mode, the peer certificate must be signed by a trusted certificate authority, such as certificate authority 510. The peer device may accept connections only from a group of devices that are signed by a specific trusted certificate authority (and/or set of trusted authorities). In this mode, the client and the server may verify that the provided peer device information matches the device type indicated by the certificate. Certain features may be enabled and/or disabled or secret data may be sent only to trusted devices. Potential issues associated with the signed by a trusted certificate authority mode include if a common certificate is issued to multiple devices (e.g., a client certificate) and if the certificate is hacked, all the devices will be exposed. This mode requires individual certificates to be issued for each device and embedded systems such as head-units may include hardware cryptography modules that may store the certificate and the associated private key, which makes breaking the encryption harder. On the smart host 100, or other server, side, rooted or jailbroken phones may have hackable certificate stores. Individual certificates may limit exposure but require an active certificate revocation list that might be hard to implement in some cases. For example, if one phone has a certificate hacked, then the same certificate may be copied to an unlimited number of other phones as a trusted certificate. The connection token signed by a trusted certificate authority mode may reduce some of these risks.

In password authentication (or “no certificate”) mode, both sides may use the single-responsibility principle (SRP) protocol. There may be a password or PIN code that may be passed out of band (e.g., outside the local connection 490). For example, the user 140 may be asked to enter on the smart host 100 (e.g., via a resource such as companion application 420) a password such as a PIN code displayed on a screen associated with client 110. After a connection has been established in this mode, each side may request a peer signed certificate from the other side and then switch to the peer-signed certificate mode. Because of the potential weaknesses of such passwords (if a four-digit pin is used) to attacks such as man-in-the-middle attacks (e.g., via brute force), the smart host resources 410, client resources 450, and/or other system resources may drop the connection after the certificates are exchanged and switch to another certificate-based secure connection mode (e.g., a TLS connection) after a short period of time. Such brute force attack may be detected and mitigated by dropping the connection and generating new password or PIN with every new connection attempt or allowing maximum of two tries, for example. The end-user 140 may act as an outside authority to confirm the connection. There may be no need for dynamic requesting of certificates from a root certificate authority, such as certificate authority 510, unlike the connection token signed by a trusted certificate authority mode. Potential issues associated with the password authentication mode include that the peer device cannot be independently authenticated (e.g., the peer device does not provide a certificate signed by a trusted certificate authority).

The connection token signed by a trusted certificate authority mode may be an extension of the signed by a trusted certificate authority mode, where one of the devices may request the peer to present a certificate (signed by trusted certificate authority) for a given connection token. This approach reduces the risk of mass hacking. For example, if the companion application 420 has a common certificate (e.g., a certificate bundled in the application) the common certificate may be extracted by a hacker. The extracted common certificate may be used to create many other spoofed applications. The connection token signed by a trusted certificate authority mode mitigates such threats by requiring the smart host resources 410 to request a certificate from the certificate authority 510 that may be specific for the particular connection (as identified via a combined connection token). The certificate authority 510 may perform additional validation of the application and block fraudulent requests. Thus, if a given smart host 100 is hacked, the certificate will only be usable for that specific combination of client 110 and connection method. The connection token signed by a trusted certificate authority mode may allow dynamic certification of smart host applications 440 and the cloud service 120 may perform additional certification and/or blacklisting. Potential issues associated with this mode include that the smart host 100 requires an Internet connection to dynamically request the signed certificate. Applications may need to allow the user 140 some level of functionality until Internet connectivity may be obtained. The peer-signed certificate mode may allow the system to operate without dynamic certificate authority access.

Various example messages that may be supported by the protocol are described herein. The messages may be implemented using different formats such as text (e.g., extensible markup language (XML), JSON, comma-separated values (CSV), etc.), binary format (e.g., protocol buffers, serialized data structures, etc.), and/or other appropriate formats. Different messages and/or message properties may be included in different embodiments.

FIG. 9 illustrates a message flow diagram of an authentication sequence 900 of one or more embodiments described herein. As shown, smart host 100 may communicate with client 110. Such communication may include and/or utilize resources such as smart host resources 410 and/or client resources 450.

For the system to work, the smart host resources 410 may need to authenticate the connected client 110. Such authentication may be performed whenever the connection to the client 110 is established. The system may require that client resources 450 are running on any connected client 110 that responds to a handshake message. The sequence 900 may be one possible example of how such authentication may be performed. Based on the capabilities of the smart host 100 and/or client 110, additional security operations may be added or in some cases fewer operations may be used (with reduced security, if acceptable).

The authentication sequence 900 may start with both sides opening a P2P packet protocol connection on top of the selected channel included in the local connection 490. After the peers 100-110 establish a connection, client 110 may send handshake 905 to smart host 100.

Smart host 100 may retrieve 910 a stored certificate, if available. Such a certificate may be similar to smart host certificate 545. If no stored certificate is available, a certificate may be generated using a protocol such as certificate generation protocol 1000.

Returning to authentication sequence 900, smart host 100 may send handshake 915 to client 110.

Handshake messages 905 and 915 may include information such as a requested authentication mode. One of the peers may request the connection token signed by a trusted certificate authority mode, which requires the other party to request a certificate from the certificate authority 510 based on a provided token. The sequence for such request may be shown in the next section.

In this example, the smart host 100 may make the certificate request to the certificate authority 510. However, such a request may be made by the client 110, as long as the client 110 has Internet connectivity. Typically, the smart host 100 may act as a server for the connection with client 110. The smart host 100 has internet connectivity and may be exposed to “hacking” more than an embedded client 110 such as an in-vehicle head-unit. After the authentication modes are exchanged and agreed upon, both sides try to establish secure connection (e.g., using TLS) using their certificates.

Smart host 100 may send TLS authentication 920 to client 110. Client 110 may send TLS authentication 925 to smart host 100.

After the secure connection is established, both sides may exchange device identity information (such as make, model number, serial number, etc.) over the secure channel using, for example, identity messages from the authentication protocol. In this example, client 110 may send device identity 930 to smart host 100 and smart host 100 may send device identity 935 to client 110. If the identifies are accepted, both sides may continue to exchange data over the secure channel via secure messages 940. The parties may open additional secure channels.

If either of the parties cannot authenticate the certificates from the other party, the connection may be terminated. Smart host 100 may tear down 945 existing channels. Client 110 may tear down 950 existing channels and/or otherwise deactivate the local connection.

Each side may reject the connection with the other side, based on the device identity messages 930-935. If the connection is rejected by smart host 100 or client 110, smart host 100 may tear down 955 existing channels and/or otherwise deactivate the local connection. If the connection is rejected by smart host 100 or client 110, client 110 may tear down 960 existing channels and/or otherwise deactivate the local connection.

FIG. 10 illustrates a message flow diagram of a certificate generation protocol 1000 of one or more embodiments described herein. As shown, smart host 100 may communicate with cloud service 120. Such communication may include and/or utilize resources such as smart host resources 410.

As part of the initial authentication sequence 900, a peer device may request the connection token signed by a trusted certificate authority mode. If the receiving device does not yet have a certificate for the requested token, the certificate must be requested from the certificate authority 510.

Smart host 100 may generate 1010 a private/public key pair using various appropriate resources. Smart host 100 may prepare 1020 a certificate signing request that may include a combined connection token. Smart host 100 may send the certificate signing request 1030 to cloud service 120. The certificate signing request may be received by a resource such as the certificate authority 510 for processing.

Cloud service 120 may validate 1040 the signing request 1030. Such validation may include, for example, evaluation of identifiers or other information associated with the requestor (e.g., device address). Validation may include various encryption and/or decryption operations using public and/or private keys of some embodiments (e.g., the signing request 1010 may include a previously-encrypted certificate that may be decrypted using a private key of the cloud service 120, such as cloud service key 515). In some embodiments, cloud service 120 may maintain a database of registered or authorized smart hosts 100 that may be used during such validation (e.g., by comparing a device identifier received with the signing request 1030 to a lookup table including registered device identifiers).

Cloud service 120 may sign 1050 the request with a private key, such as cloud service key 515, to generate a signed certificate. Cloud service 120 may send the signed certificate 1060 to smart host 100.

Smart host 100 may store 1070 the signed certificate 1060. The signed certificate may be stored locally at the smart host 100. The certificate may be stored in a secure storage.

FIG. 11 illustrates a message flow diagram of a portion of a secure connection protocol 1100 of one or more embodiments described herein. As shown, smart host 100 may communicate with client 110. In this example, the smart host 100 acts as the server and the client 110 acts as the client. Such communication may include and/or utilize resources such as smart host resources 410 and/or client resources 450.

The system may utilize a secure connection protocol (e.g., a TLS or similar protocol). As the system supports different authentication modes and certificate generation algorithms, standard protocols may not provide sufficient resources to negotiate a connection under the secure connection protocol. Additional handshake messages may be exchanged before establishing a secure connection protocol-based connection and identity messages may be exchanged after the secure connection is established.

The authentication protocol messages may be sent over a specific channel of a previously established P2P packet protocol-based connection. After the authentication is successfully completed, the peers may continue using the same channel to exchange data securely and/or the peers may open parallel secure channels. The authentication protocol does not need to be executed for those additional channels, as both sides already have the necessary certificates negotiated for the main authentication channel.

Smart host 100 may receive a configuration message 1105. Client 110 may receive a configuration message 1110. Before the peer devices are authenticated, the peer devices (via resources such as smart host resources 410 and/or client resources 450) may be configured with the expected authentication mode(s). The peers may then establish a regular data connection over the P2P packet protocol to known addresses and ports.

In this example, client 110 may retrieve 1115 a client token. Depending on the configured mode, the client 110 may retrieve (or generate if not available) 1115 a client connection token and may send a client hello message 1120 to smart host 100. The client hello message 1120 may identify the requested authentication mode that the client 110 expects from the smart host 100. The client hello message 1120 may also include the client connection token. After sending the client hello message 1120, the client 110 may expect either a server hello message or a server rejection message, as described below.

Smart host 100 may store 1125 the received client connection token. If the requested authentication method is supported, the smart host 100 may retrieve or generate 1130 a server connection token (e.g., a smart host connection token). Smart host 100 may send server hello 1135 to client 110, where the server hello message 1135 may indicate whether the smart host 100 supports the requested authentication mode, may indicate the authentication mode expected from the client 110, and may include a server connection token. After sending the server hello message 1135, the smart host 100 may expect either a client ready message or a client rejection message.

If the authentication mode requested in client hello 1120 is not supported, smart host 100 may send a client rejection message 1140 to client 110 and close 1145 the connection (e.g., by terminating or closing open channels associated with the connection). The client rejection message may be sent when either party is not able to support the requested authentication protocol. To make hacking more difficult, error codes may not be very descriptive (e.g., rejected, invalid message, temporarily cannot obtain cert, etc.).

As a result of the server hello message 1135, the client 110 may send server rejection message 1150 to smart host 100 and close 1155 the connection if, for example, the requested authentication method is not supported.

FIG. 12 illustrates a message flow diagram of another portion of the secure connection protocol 1100. If no client rejection message 1140 or server rejection message 1150 is received, client 110 may send ready 1205 to smart host 100. In some cases, smart host 100 may send a similar ready message.

The ready message 1205 may be sent by the client 110 when the client 110 accepts the server hello message 1135. From that point forward, both parties may switch to a standard secure connection protocol mode (e.g., using TLS). Both parties may be authenticated based on the presented certificates. If the certificates do not match, or the identity of the peer side does not match, each side may tear-down the connection, as described below.

Client 110 may send open connection 1210 to smart host 100. Smart host 100 may send open connection 1215 to client 110. Such open connection messages 1210-1215 may be, or be similar to, standard TLS open connection messages.

After the secure connection has been established successfully, client 110 may send device identity 1220 to smart host 100 and smart host 100 may send device identity 1225 to client 110. The device identity messages 1220-1225 may include identity information regarding each sender device, application, and/or other relevant entity identification information.

The device identity messages 1220-1225 may include a dictionary of string values that identify the device, application, and/or other entity. Certain values may be required to be provided and/or the applications may provide additional custom values. The dictionary key may be an identity value identifier and the value may be the corresponding identity value. The identity values may be name-value pairs returned by the device identity messages 1220-1225. The names are predefined and may be assigned a unique ID.

Identity identifiers may include elements such as manufacturer, model, serial number, OS, OS version, application, application vendor, application version, subject distinguished name (from, for example, the x509 certificate used to establish a TLS connection), client identifier (a unique identifier for the client device), smart host identifier (a unique identifier for the smart host), profile identifier (identifies a profile associated with a current smart host), profile current key (defines current decryption key for the profile), and/or profile next key (defines the next encryption key for the profile).

If the identity information is able to be verified and/or supported, the client and the server may exchange completion messages 1230-1235. This means that no more authentication messages will be sent over the secure channel, and it may safely be released for generic application messages. From that point on, the applications may exchange generic messages over the secure channel.

After the completion messages 1230-1235 have been sent and received, client 110 may send secure messages 1240 to smart host 100 and/or smart host 100 may send secure messages 1245 to client 110. To exchange data securely, the system may use secure exchange protocols like the TLS protocol. The system may implement the TLS or a similar protocol. Such a protocol may use similar digital certificates, algorithms and handshaking sequences to authenticate and encrypt the connection(s). The secure connection protocol may run on top of the P2P packet protocols.

If authentication fails at the smart host 100, smart host 100 may close 1250 the connection. If authentication fails at the client 110, client 110 may close 1255 the connection. Authentication may fail, for instance, when certificate information (such as decrypted information) does not match expected values or is otherwise not able to be validated.

Each side may reject the connection if the identity of the other party is not supported or the identity does not match the associated certificate. For example, if the subject distinguished name does not match that of the certificates, the party may send a rejection or error message 1260 that may include one or more error codes.

One of ordinary skill in the art will recognize that sequences and protocols 900-1100 may be implemented in various different ways without departing from the scope of the disclosure. For instance, single messages may be divided into sub-element such as packets. As another example, multiple message elements may be combined into a single message. Messages may be sent in different orders than shown. Additional messages and/or other operations may be included and/or some listed messages and/or other operations may be omitted.

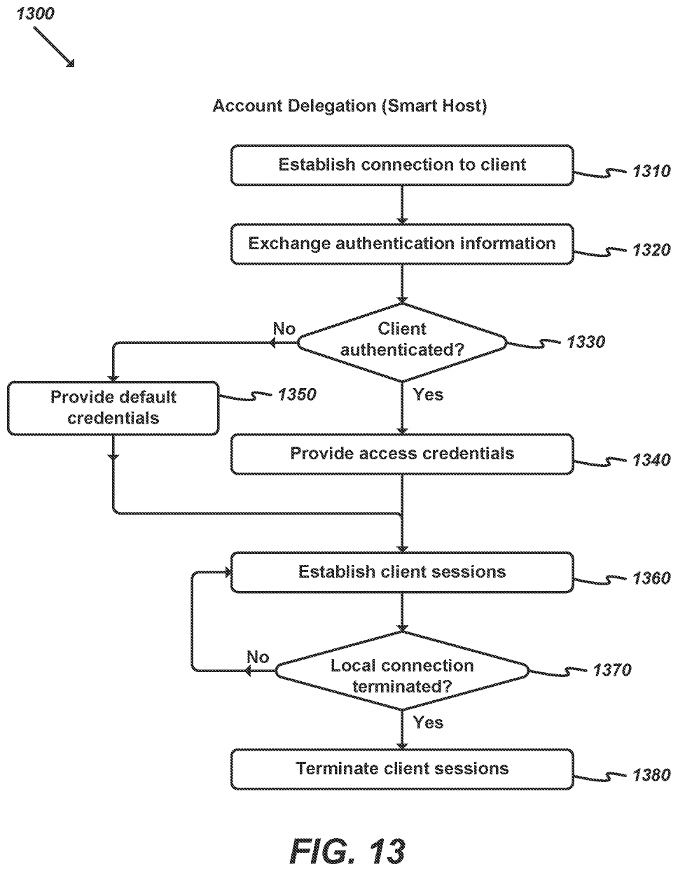

FIG. 13 illustrates an example process 1300 for delegating account information from a smart host 100 to a client 110. The process may allow the client 110 to access services and/or data using credentials provided by the smart host 100. Such services and/or data may be provided by, or via, resources such as network resources 130. The process may be performed when a smart host 100 is turned on, when a companion application 420 is launched, and/or under other appropriate conditions (e.g., when a system client 110, such as a client 110 running client resources 450, is detected by smart host 100). In some embodiments, process 1300 may be performed by smart host 100. Client 110 may perform a similar complementary process. Cloud service 120 may perform a complementary process.

As shown, process 1300 may include establishing (at 1310) a connection to a client 110. The connection may be similar to connection 490. Such a connection may be established in various appropriate ways, using various appropriate connection channels. For instance, the smart host 100 and/or client 110 may communicate using BT and may detect a signal (e.g., a beacon signal) from the other device. As another example, a device scan may be implemented at regular intervals by a resource such as companion application 420. In some cases, a list of available devices may be presented and/or selections may be received from a user 140 via a resource such as companion application 420.

Process 1300 may include exchanging (at 1320) authentication information with the client. As described above, various information element may be exchanged depending on the relevant authentication mode(s).

The process may include determining (at 1330) whether the client 110 has been authenticated. As described above, such authentication may include comparison of information such as client identifiers to a listing of registered clients. As another example, client authentication may include analysis of certificates and/or other authentication information received from the client 110. Such analysis may include decryption using private and/or public keys.

If process 1300 determines (at 1320) that the client 110 has been authenticated, the process may include providing (at 1340) access credentials. As described above, depending on the authentication mode, various sets of authentication criteria may need to be satisfied in order for access credentials to be provided. Access credentials may include, for instance, tokens, session information, temporary login information (e.g., username and temporary password), and/or other relevant information that may be utilized to access data and/or services from resources such as network resources 130. Such temporary login information may expire based on various relevant criteria (e.g., time since creation, time since last action, verification of an active local connection, etc.). The information included with access credentials may depend on capabilities and/or features of the client 110, smart host 100, and/or other resources (e.g., client applications 470). Access credentials may include preferences such as permission levels associated with underlying client sessions, for example.

If process 1300 determines (at 1320) that the client 110 has not been authenticated, the process may include providing (at 1350) default credentials. Such default credentials and/or null credentials may allow users 140 that are not associated with a smart host 100 (or are associated with a smart host that does not run companion application 420) to use the client 110, where in some cases the user may be asked to enter login or other information upon launching a particular client application 470.

For secure or access-controlled devices (e.g., industrial or medical devices), if the process determines (at 1320) that the client 110 has not been authenticated, the process may disable client 110 and/or otherwise prevent use of the client resources.

The process may include establishing (at 1360) one or more client sessions and/or login sessions. Such client sessions may be associated with resources such as client applications and/or services 470.

As shown, process 1300 may include determining (at 1370) whether the local connection has been terminated. Such a determination may be made in various appropriate ways, depending on the particular connection channel(s). For instance, a ping or similar message may be sent to the other party. If no response is received, the connection may be determined to be terminated. As another example, a resource such as companion application 420 may receive an explicit request to terminate the local connection.

If process 1300 determines (at 1370) that the local connection has not been terminated, the process may maintain and/or establish (at 1360) client sessions as necessary until the process determines (at 1370) that the local connection has been terminated.

If process 1300 determines (at 1370) that the local connection has been terminated, the process may include terminating (at 1380) client sessions and/or login sessions. Such termination may include sending messages to various parties (e.g., network resources 130) and/or otherwise terminating the active client sessions. In some cases, a resource such as smart host 100 may send termination messages (if communication channels are available) to resources such as client applications 470, network resources 130, client 110, etc.

In addition to, and/or instead of, terminating the local connection, some embodiments may delete, encrypt, and/or otherwise protect any personal data associated with the user 140 such that the data is not exposed to other users in future sessions.

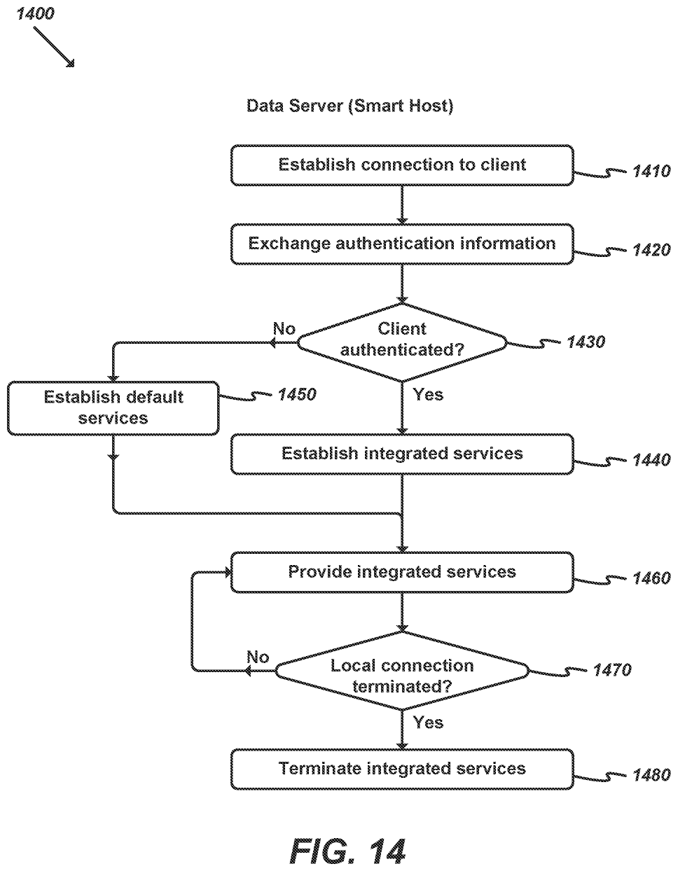

FIG. 14 illustrates an example process 1400 for providing data services from a smart host 100 to a client 110. The process may allow the client 110 to access services and/or data using credentials provided by the smart host 100. Such services and/or data may be provided by, or via, resources such as client applications 470. The process may be performed when a smart host 100 is turned on, when a companion application 420 is launched, and/or under other appropriate conditions (e.g., when a system client 110, such as a client 110 running client resources 450, is detected by smart host 100). In some embodiments, process 1400 may be performed by smart host 100. Client 110 may perform a similar complementary process. Cloud service 120 may perform a complementary process.

As shown, process 1400 may include establishing (at 1410) a connection to a client. Operation 1410 may be similar to operation 1310 described above.

Process 1400 may include exchanging (at 1420) authentication information. Operation 1420 may be similar to operation 1320 described above.

The process may include determining (at 1430) whether the client has been authenticated. Operation 1430 may be similar to operation 1330 described above.

If process 1400 determines (at 1430) that the client has been authenticated, the process may include establishing (at 1440) integrated services. Such integrated services may be provided via a resource such as local connection 490. To provide services, smart host 100 may launch resources such as applications 440, companion application 420, smart host resources 410, and/or other appropriate resources.

If process 1400 determines (at 1430) that the client has not been authenticated, the process may include establishing (at 1450) default services, such as services that do not require an Internet connection. Such default service may allow users 140 that are not associated with a smart host 100 (or are associated with a smart host that does not run companion application 420) to use the client 110, where in some cases the user may be asked to enter login or other information upon launching a particular client application 470.

The process may include providing (at 1460) integrated services. Such integrated services may be provided via a resource such as local connection 490. Integrated services may be provided using, or via, resources such as smart device applications 440 and/or network resources 130. The client 110 may access such integrated services may include the smart host services described herein. The integrated services may be accessed via resources such as one or more APIs such that the client 110 may interact with the smart host 100 similarly to associated network resources 130 if the client 110 were able to access the network resources 130 directly.

As shown, process 1400 may include determining (at 1470) whether the local connection has been terminated. Operation 1470 may be similar to operation 1370 described above.

If process 1400 determines (at 1470) that the local connection has not been terminated, the process may continue providing (at 1460) integrated services until the process determines (at 1470) that the local connection has been terminated.

If the process determines (at 1470) that the local connection has been terminated, the process may include terminating (at 1480) integrated services. Such termination may include sending messages to various parties (e.g., network resources 130) and/or otherwise terminating the active service (e.g., by disabling or closing smart host applications 440 associated with provided services, by disabling the smart host services interface, etc.). In some cases, a resource such as smart host 100 may send termination messages (if communication channels are available) to resources such as client applications 470, network resources 130, client 110, etc.

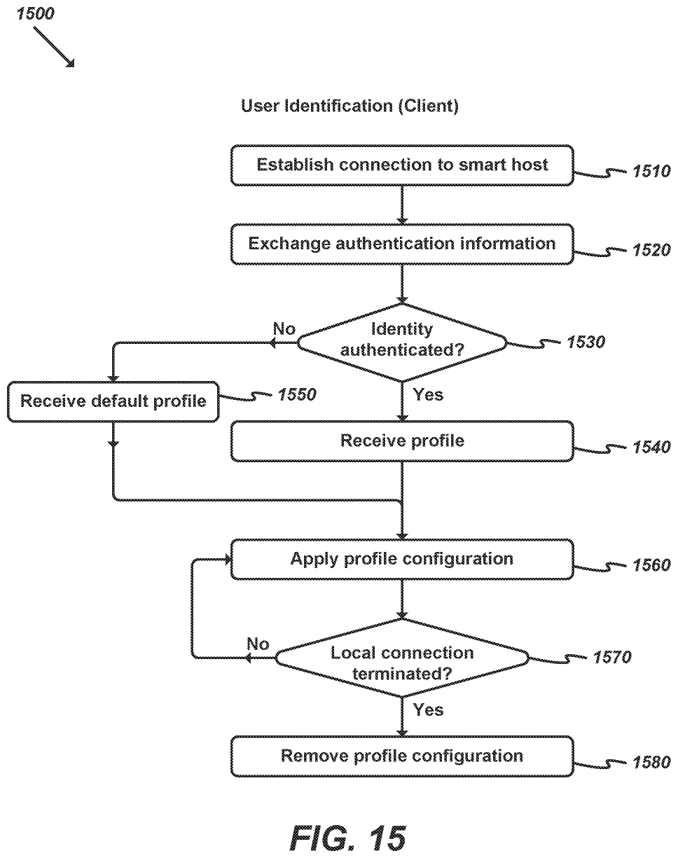

FIG. 15 illustrates an example process 1500 for identifying a user 140 at a client 110. The process may allow the client 110 to identify users 140 via the smart host 100. Such identification may be provided by, or via, resources such as client resources 450 and/or smart host resources 410. The process may be performed when a client 110 is turned on and/or under other appropriate conditions (e.g., when a system smart host 100, such as a smart host 100 running smart host resources 410, is detected by client 110). In some embodiments, process 1500 may be performed by client 110. Smart host 100 may perform a similar complementary process. Cloud service 120 may perform a complementary process.

As shown, process 1500 may include establishing (at 1510) a connection to a smart host 100. Operation 1510 may be similar to (and complementary to) operation 1310 described above. If multiple smart hosts 100 are available (e.g., if multiple people with smartphones enter a vehicle at the same time), a selection may be made via a resource such as a vehicle head unit, a default selection may be made based on a saved hierarchy (e.g., the owner or primary driver of a vehicle may be selected if available, a secondary driver selected if the primary driver is not available, etc.), and/or otherwise make a selection from the available smart host (e.g., based on signal strength, support authentication mode(s), etc.).

Process 1500 may include exchanging (at 1520) authentication information with the smart host. Operation 1520 may be similar to (and complementary to) operation 1320 described above.

The process may include determining (at 1530) whether the host identity has been authenticated. Operation 1530 may be similar to operation 1330 described above.

If process 1500 determines (at 1530) that the host identify has been authenticated, the process may include receiving (at 1540) an associated profile. Such a profile may be received from local storage of the client 110 and/or other appropriate resources (e.g., cloud service 120, network resources 130, etc.). As described herein, the profile may include information associated with a user, such as login information or other appropriate credentials, preferences or settings, etc.

If process 1500 determines (at 1530) that the host identify has not been authenticated, the process may include receiving (at 1550) a default profile. Such a default and/or null profile may allow users 140 that are not associated with a smart host 100 (or are associated with a smart host that does not run companion application 420) to use the client 110, where in some cases the user may be asked to enter login or other information upon launching a particular client application 470.

The process may include applying (at 1560) a profile configuration. Settings associated with the profile received (at 1540) or the default profile received (at 1550) may be applied to the client 110. Such application may include, for instance, communicating with various client components or sub-systems. For example, account information or preferences for a streaming radio service may be sent to an in-vehicle infotainment unit. As another example, user comfort settings (e.g., seat position, mirror position, etc.) may be received from a local storage of the client 110.

As shown, process 1500 may include determining (at 1570) whether the local connection has been terminated. Operation 1570 may be similar to (and complementary to) operation 1370 described above.

If process 1500 determines (at 1570) that the local connection has not been terminated, the process may continue to apply (at 1560) the profile configuration until the process determines (at 1570) that the local connection has been terminated.

If process 1500 determines (at 1570) that the local connection has been terminated, the process may include removing (at 1580) the profile configuration. Removing the profile configuration may include applying default settings, removing access to storages (and/or deleting files), and/or otherwise returning to a previous or default state. Some profile configuration settings may be retained. For instance, seat position settings may not be changed until a different profile is detected.

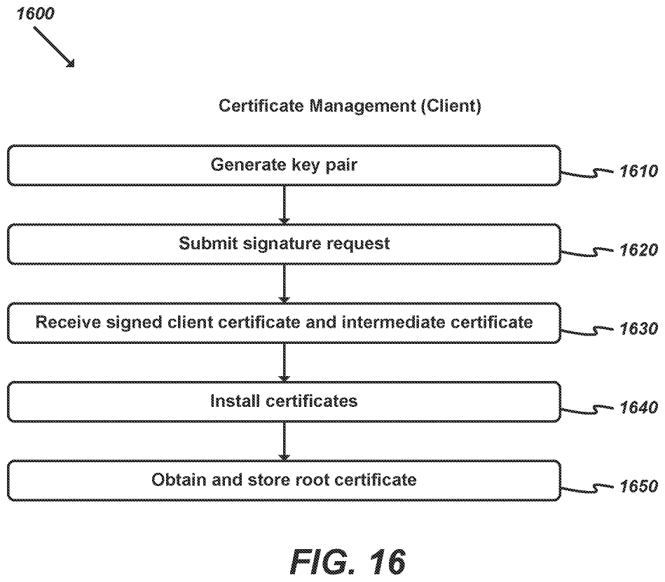

FIG. 16 illustrates an example process 1600 for managing certificates at a client 110. The process may allow the client 110 to manage certificates with the cloud resource 120 and/or other appropriate certificate authority, such as certificate authority 510. Such certificate management may be provided by, or via, resources such as client resources 450. The process may be performed when a client 110 is turned on and/or under other appropriate conditions (e.g., when updated certificates are available, if applicable). In some embodiments, process 1600 may be performed by client 110. Cloud service 120 may perform a similar complementary process.

As shown, process 1600 may include generating (at 1610) a key pair. Such a key pair may be generated by a resource such as a client device supplier or manufacturer. The private key may be kept secret on the client side. A unique private key may be associated with each client device 110. In some cases, a unique private key may be associated with each client device model or some other set of client devices 110.

Process 1600 may include submitting (at 1620) a signature request. The signature request may be submitted by the client device supplier or other appropriate resource to a resource such as certificate authority 510. The signature request may include information such as metadata (e.g., vendor identifier, model identifier, serial number, etc.). The signature request may be sent over a connection such as a VPN connection. A resource such as a cloud service intermediate certificate authority may digitally sign the certificate with an intermediate private key.

The process may include receiving (at 1630) the signed client certificate and intermediate certificate. The certificates may be received from the certificate authority 510.

As shown, process 1600 may include installing (at 1640) the signed client certificate and intermediate certificate. The certificates may be stored, or installed, to the associated client device(s) 110. The private key may be stored in a secure location on the system (e.g., a HSM).

Process 1600 may include obtaining and storing (at 1650) a root certificate. Such a root certificate may be received from a resource such as certificate authority 510 and stored on client device 110.

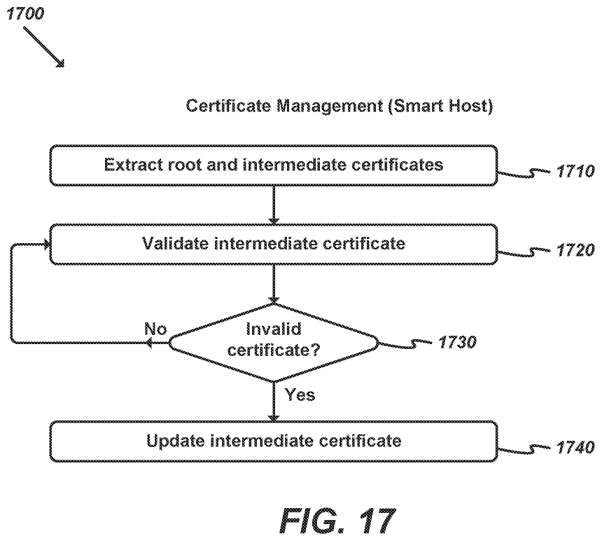

FIG. 17 illustrates an example process 1700 for managing certificates at a smart host 100. The process may allow the smart host 100 to manage certificates with the cloud resource 120 and/or other appropriate certificate authority, such as certificate authority 510. Such certificate management may be provided by, or via, resources such as smart host resources 410. The process may be performed when a smart host 100 is turned on, when a companion application 420 is installed, and/or under other appropriate conditions (e.g., when updated certificates are available, if applicable). Cloud service 120 may perform a complementary process.

In order to authenticate a client 110 when the signed by a trusted certificate authority authentication mode is used, the companion application 420 may need to have access to the cloud service intermediate certificate and root certificate 540. The latest versions of the root certificate 540 and the intermediate certificate may be provided as part of the smart device resources 410 and may be bundled into the application resources of companion application 420 when built. The application may be signed for distribution using, for example, a private developer key (Android), a distribution profile (iOS), and/or other appropriate resource. Resources cannot be modified inside the companion application 420 without re-signing the companion application 420, thus the certificates may not be modified inside the application 420. The companion application 420 may be distributed via a resource such as an application store.

As shown, process 1700 may include extracting (at 1710) root and intermediate certificates. The extracted certificates may be stored to a resource such as a private application keystore on the smart host 100. A resource such as certification manager 710 may extract and store the certificates.

The process may include validating (at 1720) the intermediate certificate. A resource such as certification manager 710 may validate the intermediate certificate via the intermediate certificate authority.

As shown, process 1700 may include determining (at 1730) whether the intermediate certificate is still valid. Such a determination may be made based on various relevant factors, such as communication with the intermediate certificate authority.

If process 1700 determines (at 1730) that the intermediate certificate is not invalid, the process may periodically re-validate (at 1720) the intermediate certificate until the process determines (at 1730) that the intermediate certificate is invalid.

If the process determines (at 1740) that the intermediate certificate is invalid, the process may include updating (at 1750) the intermediate certificate by removing the old certificate from the keystore and downloading and storing the new intermediate certificate to the keystore.

One of ordinary skill in the art will recognize that processes 1300-1700 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that may be readable by electronic devices.

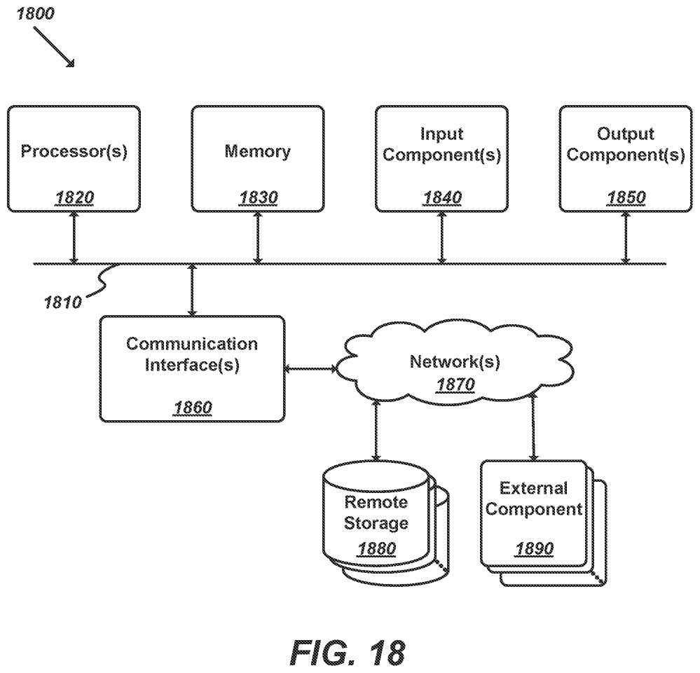

FIG. 18 illustrates a schematic block diagram of an exemplary device (or system or devices) 1800 used to implement some embodiments. For example, the systems, devices, components, and/or operations described above in reference to FIG. 1, FIG. 2, FIG. 3, FIG. 4, FIG. 5, FIG. 6, FIG. 7, FIG. 8, FIG. 9, FIG. 10, FIG. 11, and FIG. 12 may be at least partially implemented using device 1800. As another example, the processes described in reference to FIG. 13, FIG. 14, FIG. 15, FIG. 16, and FIG. 17 may be at least partially implemented using device 1800.

Device 1800 may be implemented using various appropriate elements and/or sub-devices. For instance, device 1800 may be implemented using one or more personal computers (PCs), servers, mobile devices (e.g., smartphones), tablet devices, wearable devices, and/or any other appropriate devices. The various devices may work alone (e.g., device 1800 may be implemented as a single smartphone) or in conjunction (e.g., some components of the device 1800 may be provided by a mobile device while other components are provided by a server).

As shown, device 1800 may include at least one communication bus 1810, one or more processors 1820, memory 1830, input components 1840, output components 1850, and one or more communication interfaces 1860.

Bus 1810 may include various communication pathways that allow communication among the components of device 1800. Processor 1820 may include a processor, microprocessor, microcontroller, digital signal processor, logic circuitry, and/or other appropriate processing components that may be able to interpret and execute instructions and/or otherwise manipulate data. Memory 1830 may include dynamic and/or non-volatile memory structures and/or devices that may store data and/or instructions for use by other components of device 1800. Such a memory device 1830 may include space within a single physical memory device or spread across multiple physical memory devices.

Input components 1840 may include elements that allow a user to communicate information to the computer system and/or manipulate various operations of the system. The input components may include keyboards, cursor control devices, audio input devices and/or video input devices, touchscreens, motion sensors, etc. Output components 1850 may include displays, touchscreens, audio elements such as speakers, indicators such as light-emitting diodes (LEDs), printers, haptic or other sensory elements, etc. Some or all of the input and/or output components may be wirelessly or optically connected to the device 1800.

Device 1800 may include one or more communication interfaces 1860 that are able to connect to one or more networks 1870 or other communication pathways. For example, device 1800 may be coupled to a web server on the Internet such that a web browser executing on device 1800 may interact with the web server as a user interacts with an interface that operates in the web browser. Device 1800 may be able to access one or more remote storages 1880 and one or more external components 1890 through the communication interface 1860 and network 1870. The communication interface(s) 1860 may include one or more APIs that may allow the device 1800 to access remote systems and/or storages and also may allow remote systems and/or storages to access device 1800 (or elements thereof).

It should be recognized by one of ordinary skill in the art that any or all of the components of computer system 1800 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1800 may perform various operations in response to processor 1820 executing software instructions stored in a computer-readable medium, such as memory 1830. Such operations may include manipulations of the output components 1850 (e.g., display of information, haptic feedback, audio outputs, etc.), communication interface 1860 (e.g., establishing a communication channel with another device or component, sending and/or receiving sets of messages, etc.), and/or other components of device 1800.

The software instructions may be read into memory 1830 from another computer-readable medium or from another device. The software instructions stored in memory 1830 may cause processor 1820 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment may be not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) may be used herein to describe a relationship of a value to a threshold, it may be to be understood that the term “greater than or equal to” (or similar terms) may be similarly contemplated, even if not explicitly stated. Similarly, to the extent that the term “less than” (or similar terms) may be used herein to describe a relationship of a value to a threshold, it may be to be understood that the term “less than or equal to” (or similar terms) may be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” may be intended to include one or more items and may be used interchangeably with the phrase “one or more.” Where only one item may be intended, the terms “one,” “single,” “only,” or similar language may be used. Further, the phrase “based on” may be intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A smart host device, comprising:
one or more processors configured to:
establish, at the smart host device, a local connection to a client device;
exchange authentication information with the client device over the local connection;
establish, at the smart host device, at least one client session on behalf of the client device with a network resource using account credentials stored at the smart host device;
determine that the local connection between the smart host device and the client device has been terminated; and
terminate the at least one client session based on the determination that the local connection between the smart host device and the client device has been terminated.

2. The smart host device of claim 1, wherein exchanging authentication information comprises sending, from the smart host device, a smart host certificate to the client device and receiving, at the smart host device, a client certificate from the client device.

3. The smart host device of claim 2, the one or more processors further configured to verify the client certificate via a cloud service certificate authority.

4. The smart host device of claim 1, the one or more processors further configured to provide a service interface to the client device, the service interface providing access to the network resource via the smart host device using account credentials stored at the smart host device.

5. The smart host device of claim 4, wherein the service interface implements at least one of an Internet message access protocol (IMAP), post office protocol 3 (POP3), simple mail transfer protocol (SMTP), calendar protocol, contact protocol, or session initiation protocol (SIP).

6. The smart host device of claim 1, wherein the smart host device is a smartphone, wearable device, or tablet.

7. The smart host device of claim 1, wherein the local connection comprises at least one of a universal serial bus (USB) channel, Bluetooth channel, Bluetooth low Energy (BLE) channel, Wi-Fi channel, ultra-wide band (UWB) channel, or near-field communication (NFC) channel.

8. A non-transitory computer-readable medium, storing a plurality of processor executable instructions to:
establish, at a smart host device, a local connection to a client device;
exchange authentication information with the client device over the local connection;
establish, at the smart host device, at least one client session on behalf of the client device with a network resource using account credentials stored at the smart host device;
determine that the local connection has been terminated; and
terminate the at least one client session based on the determination that the local connection between the smart host device and the client device has been terminated.

9. The non-transitory computer-readable medium of claim 8, wherein exchanging authentication information comprises sending a smart host certificate to the client device and receiving a client certificate from the client device.

10. The non-transitory computer-readable medium of claim 9, the plurality of processor executable instructions further to verify the client certificate via a cloud service certificate authority.

11. The non-transitory computer-readable medium of claim 8, the plurality of processor executable instructions further to provide a service interface to the client device, the service interface providing access to the network resource via the smart host device using account credentials stored at the smart host device.

12. The non-transitory computer-readable medium of claim 11, wherein the service interface implements at least one of an Internet message access protocol (IMAP), post office protocol 3 (POP3), simple mail transfer protocol (SMTP), calendar protocol, contact protocol, or session initiation protocol (SIP).

13. The non-transitory computer-readable medium of claim 8, wherein the smart host device is a smartphone, wearable device, or tablet.

14. The non-transitory computer-readable medium of claim 8 wherein the local connection comprises at least one of a universal serial bus (USB) channel, Bluetooth channel, Bluetooth low Energy (BLE) channel, Wi-Fi channel, ultra-wide band (UWB) channel, or near-field communication (NFC) channel.

15. A method comprising:
establishing, at a smart host device, a local connection to a client device;
exchanging authentication information with the client device over the local connection;
establishing, at the smart host device, at least one client session on behalf of the client device with a network resource using account credentials stored at the smart host device;
determining that the local connection has been terminated; and
terminating the at least one client session based on the determination that the local connection between the smart host device and the client device has been terminated.

16. The method of claim 15, wherein exchanging authentication information comprises sending a smart host certificate to the client device and receiving a client certificate from the client device.

17. The method of claim 16 further comprising verifying the client certificate via a cloud service certificate authority.

18. The method of claim 15 further comprising providing a service interface to the client device, the service interface providing access to the network resource via the smart host device using account credentials stored at the smart host device.

19. The method of claim 18, wherein the service interface implements at least one of an Internet message access protocol (IMAP), post office protocol 3 (POP3), simple mail transfer protocol (SMTP), calendar protocol, contact protocol, or session initiation protocol (SIP).

20. The method of claim 15, wherein the smart host device is a smartphone, wearable device, or tablet and wherein the local connection comprises at least one of a universal serial bus (USB) channel, Bluetooth channel, Bluetooth low Energy (BLE) channel, Wi-Fi channel, ultra-wide band (UWB) channel, or near-field communication (NFC) channel.
